(19) United States
(12) Patent Application Publication
(10) Pub. No.: US 2011/0223890 A1
(43) Pub. Date: Sep. 15, 2011

(54) METHOD AND SYSTEM FOR PROVIDING GROUP DIRECTORY SERVICES FOR MOBILE COMMUNICATION DEVICES

(75) Inventors: James D. Patterson, Kansas City, MO (US); Sue E. Brothers, Shawnee, KS (US)

(73) Assignee: Mobile Symmetry, LLC, Fairway, KS (US)

(21) Appl. No.: 13/043,735

(22) Filed: Mar. 9, 2011

Related U.S. Application Data
(60) Provisional application No. 61/312,996, filed on Mar. 11, 2010.

(51) Int. Cl. H04W 4/02

(52) U.S. Cl. 455/414.1

(57) ABSTRACT

A method of providing group directory services for mobile communication devices includes the steps of maintaining a registry of user profiles established and maintained by mobile communication device users, wherein each user profile includes data representative of a user's name and preferred contact method; and permitting a group administrator to access the registry and create a group directory consisting of at least some members who have user profiles in the registry by linking the members' user profiles to the group directory.

### RELATED APPLICATIONS

The present application claims the priority benefit of U.S. Provisional Patent Application Ser. No. 61/312,996 entitled “MOBILE AND ONLINE MICRO DIRECTORY FOR CELL PHONES AND OTHER MOBILE COMMUNICATIONS DEVICES,” filed Mar. 11, 2010, the entire disclosure of which is incorporated herein by reference.

### BACKGROUND

The present invention relates to wireless communications. More particularly, the invention relates to a method and system for providing contact information and group directory services for mobile communication devices.

Phone numbers and other contact information for mobile communication device users is often difficult to obtain. Wireless phone services are typically provided by numerous different wireless carriers, each of which maintains contact information for its own customers but not other carriers' customers. Thus, a person wishing to find a mobile phone number must first know the user's carrier. Even when a user's carrier is known, it may refuse to provide phone numbers for its subscribers to prevent sales calls and other unwanted calls and texts.

This problem is compounded for groups such as sports teams, church groups, clubs, etc. that have many members who wish to be contacted via their mobile communication devices. Such groups often publish paper or on-line directories of their members, but these directories are time-consuming to create and become quickly out-dated as members change their contact information and/or come and go from the groups.

Many on-line directory services have been developed and/or proposed to provide contact information for mobile communication device users, but none have been widely adopted due to various limitations. Similarly, mobile or on-line group directory services have been developed, but they too suffer from various limitations that limit their utility. Accordingly, there is a need for an improved method and system for providing contact information and group directory services for mobile communication device users.

### SUMMARY

The present invention solves the above-described problems and provides a distinct advance in the art of wireless communications. More particularly, the present invention provides an improved method and system for providing cross-carrier contact information and group directory services for mobile communication device users.

An embodiment of the invention provides a central registry of user profiles established and maintained by mobile communication device users. Each user profile may include, among other information, a user's name and mobile phone number and permission information that enables the user to select how and by whom they are contacted. Importantly, the user profile owners themselves control the content and appearance of their user profiles and decide how they wish to be contacted, if at all.

Another embodiment of the invention provides a method and system for creating group directories from the information stored in the central registry. Anyone with a profile in the registry may access the registry or another computer system and request to create a group directory. The user who creates the group directory, referred to herein as the “administrator”, first provides the names of desired members for the group directory. The registry or another computer system then searches for the user profiles of the desired members and sends them invitations to join the group directory. When a member accepts the invitation, his or her user profile is linked to the group directory. This permits administrators to quickly and easily create group directories with existing user profiles stored in the registry or to invite users without existing user profiles to create a user profile and join the requested group directory.

Each person with a user profile in the registry may create different profiles and then designate who can access each profile. For example, a user profile may include a public profile that can be viewed by anyone with access to the registry, a private profile that can only be viewed by designated people, and a business profile that can be viewed by other designated people. When a member accepts an invitation to join a group directory, he or she may pick which profile to be included in the directory. This permits users to join many different group directories and to pick which profile is the most appropriate for each.

Once a group directory is created, the administrator or another group member authorized by the administrator may access the registry and create a message to be sent to the members. When a message is created, the registry accesses the user profiles of all the members designated to receive the message and assembles and renders the message in the format required by each member's user profile. For example, the registry may format and send the message as an email to one member, a text message to another, a computer-generated voicemail message to yet another, and a Skype message to another. The members may also elect to receive a combination of message types such as an email message and a voicemail message. Importantly, each member of the group directory gets to elect how they wish to receive the message, if at all.

Importantly, the registry of user profiles and all other features of the present invention follow guidelines of the Children's Online Privacy Protection Act (COPPA) and similar pending proposals for children and minors (children are under 13 years of age, minors are 13 or older and under 18). All child and minor profile information is protected starting with the initial requests for information from the child/minor, through the gathering of the information, and to the storing and access of the information. For example, a child is only allowed to have a private view in a group directory as defined below, whereas a minor may have a public view and a private view. For a child profile, one or more parents or other responsible adults must be designated, and the responsible adult(s) must approve the child's profile before it is posted and added to a group directory. The responsible adult must also approve all views of the profile, which group directories the child opts into, and any changes to the profile. Similar protections are provided for minor profiles, except with a minor profile, the responsible adult(s) must approve the initial profile and then may elect to either approve all profile changes and directory access or just be notified of the same.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of exemplary computer and communications equipment that may be used to implement embodiments of the present invention.

FIG. 2 is a flow chart depicting certain steps in one or more methods of the present invention and/or the functionality of certain code segments of one or more computer programs of the present invention.

FIG. 3 is a flow chart depicting certain steps in one or more methods of the present invention and/or the functionality of certain code segments of one or more computer programs of the present invention.

FIG. 4 is an exemplary screen shot that may be displayed by a computer, mobile communication device, or other electronic device while implementing one of the methods of the present invention and/or the computer programs of the present invention.

FIG. 5 is an exemplary screen shot that may be displayed by a computer, mobile communication device, or other electronic device while implementing one of the methods of the present invention and/or the computer programs of the present invention.

FIG. 6 is an exemplary screen shot that may be displayed by a computer, mobile communication device, or other electronic device while implementing one of the methods of the present invention and/or the computer programs of the present invention.

FIG. 7 is an exemplary screen shot that may be displayed by a computer, mobile communication device, or other electronic device while implementing one of the methods of the present invention and/or the computer programs of the present invention.

FIG. 8 is an exemplary screen shot that may be displayed by a computer, mobile communication device, or other electronic device while implementing one of the methods of the present invention and/or the computer programs of the present invention.

FIG. 9 is an exemplary screen shot that may be displayed by a computer, mobile communication device, or other electronic device while implementing one of the methods of the present invention and/or the computer programs of the present invention.

FIG. 10 is an exemplary screen shot that may be displayed by a computer, mobile communication device, or other electronic device while implementing one of the methods of the present invention and/or the computer programs of the present invention.

FIG. 11 is an exemplary screen shot that may be displayed by a computer, mobile communication device, or other electronic device while implementing one of the methods of the present invention and/or the computer programs of the present invention.

FIG. 12 is an exemplary screen shot that may be displayed by a computer, mobile communication device, or other electronic device while implementing one of the methods of the present invention and/or the computer programs of the present invention.

FIG. 13 is an exemplary screen shot that may be displayed by a computer, mobile communication device, or other electronic device while implementing one of the methods of the present invention and/or the computer programs of the present invention.

FIG. 14 is an exemplary screen shot that may be displayed by a computer, mobile communication device, or other electronic device while implementing one of the methods of the present invention and/or the computer programs of the present invention.

FIG. 15 is an exemplary screen shot that may be displayed by a computer, mobile communication device, or other electronic device while implementing one of the methods of the present invention and/or the computer programs of the present invention.

FIG. 16 is an exemplary screen shot that may be displayed by a computer, mobile communication device, or other electronic device while implementing one of the methods of the present invention and/or the computer programs of the present invention.

FIG. 17 is an exemplary screen shot that may be displayed by a computer, mobile communication device, or other electronic device while implementing one of the methods of the present invention and/or the computer programs of the present invention.

FIG. 18 is an exemplary screen shot that may be displayed by a computer, mobile communication device, or other electronic device while implementing one of the methods of the present invention and/or the computer programs of the present invention.

FIG. 19 is an exemplary screen shot that may be displayed by a computer, mobile communication device, or other electronic device while implementing one of the methods of the present invention and/or the computer programs of the present invention.

FIG. 20 is another exemplary screen shot that may be displayed by a mobile communication device or other electronic device while implementing one of the methods of the present invention and/or the computer programs of the present invention.

FIG. 21 is an exemplary screen shot that may be displayed by a computer, mobile communication device, or other electronic device while implementing one of the methods of the present invention and/or the computer programs of the present invention.

FIG. 22 is an exemplary screen shot that may be displayed by a computer, mobile communication device, or other electronic device while implementing one of the methods of the present invention and/or the computer programs of the present invention.

FIG. 23 is an exemplary screen shot that may be displayed by a computer, mobile communication device, or other electronic device while implementing one of the methods of the present invention and/or the computer programs of the present invention.

FIG. 24 is an exemplary screen shot that may be displayed by a computer, mobile communication device, or other electronic device while implementing one of the methods of the present invention and/or the computer programs of the present invention.

FIG. 25 is an exemplary screen shot that may be displayed by a computer, mobile communication device, or other electronic device while implementing one of the methods of the present invention and/or the computer programs of the present invention.

FIG. 26 is an exemplary screen shot that may be displayed by a computer, mobile communication device, or other electronic device while implementing one of the methods of the present invention and/or the computer programs of the present invention.

FIG. 27 is an exemplary screen shot that may be displayed by a computer, mobile communication device, or other electronic device while implementing one of the methods of the present invention and/or the computer programs of the present invention.

FIG. 28 is an exemplary screen shot that may be displayed by a computer, mobile communication device, or other electronic device while implementing one of the methods of the present invention and/or the computer programs of the present invention.

FIG. 29 is an exemplary screen shot that may be displayed by a computer, mobile communication device, or other electronic device while implementing one of the methods of the present invention and/or the computer programs of the present invention.

FIG. 30 is an exemplary screen shot that may be displayed by a computer, mobile communication device, or other electronic device while implementing one of the methods of the present invention and/or the computer programs of the present invention.

FIG. 31 is an exemplary screen shot that may be displayed by a computer, mobile communication device, or other electronic device while implementing one of the methods of the present invention and/or the computer programs of the present invention.

FIG. 32 is an exemplary screen shot that may be displayed by a computer, mobile communication device, or other electronic device while implementing one of the methods of the present invention and/or the computer programs of the present invention.

FIG. 33 is an exemplary screen shot that may be displayed by a computer, mobile communication device, or other electronic device while implementing one of the methods of the present invention and/or the computer programs of the present invention.

FIG. 34 is an exemplary screen shot that may be displayed by a computer, mobile communication device, or other electronic device while implementing one of the methods of the present invention and/or the computer programs of the present invention.

FIG. 35 is an exemplary screen shot that may be displayed by a computer, mobile communication device, or other electronic device while implementing one of the methods of the present invention and/or the computer programs of the present invention.

FIG. 36 is an exemplary screen shot that may be displayed by a computer, mobile communication device, or other electronic device while implementing one of the methods of the present invention and/or the computer programs of the present invention.

FIG. 37 is an exemplary screen shot that may be displayed by a computer, mobile communication device, or other electronic device while implementing one of the methods of the present invention and/or the computer programs of the present invention.

FIG. 38 is an exemplary screen shot that may be displayed by a computer, mobile communication device, or other electronic device while implementing one of the methods of the present invention and/or the computer programs of the present invention.

FIG. 39 is an exemplary screen shot that may be displayed by a computer, mobile communication device, or other electronic device while implementing one of the methods of the present invention and/or the computer programs of the present invention.

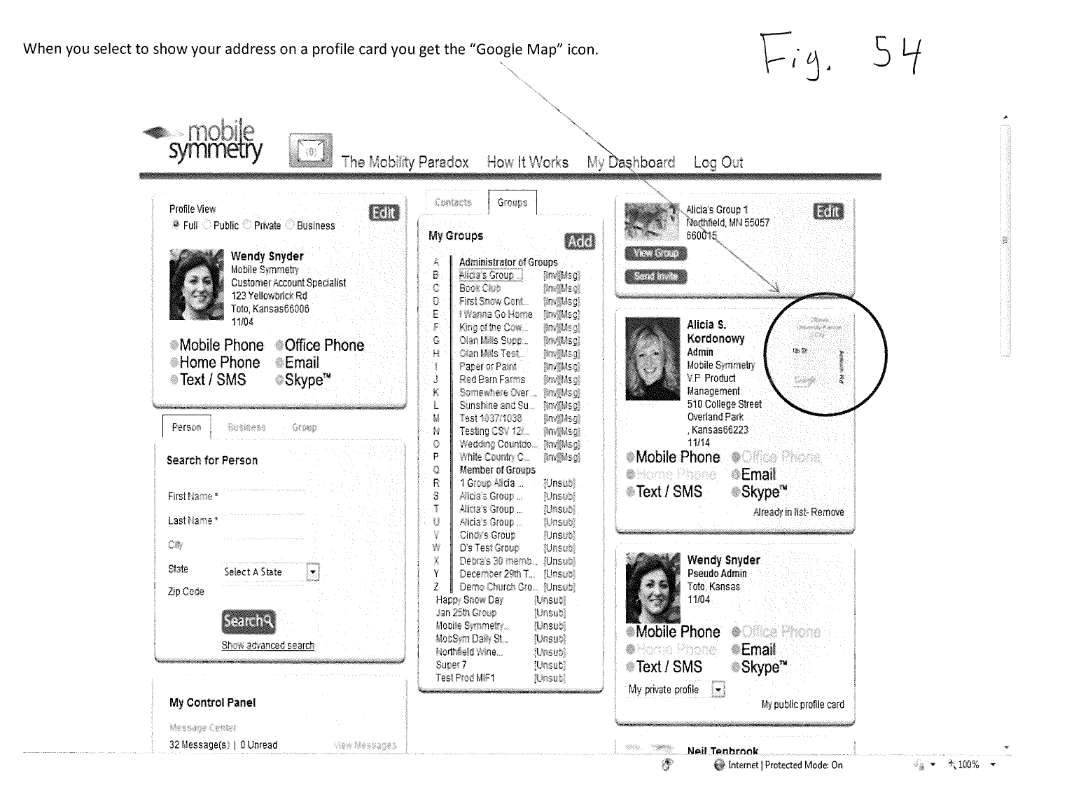

FIG. 38 is an exemplary screen shot that may be displayed by a computer, mobile communication device, or other electronic device while implementing one of the methods of the present invention and/or the computer programs of the present invention.

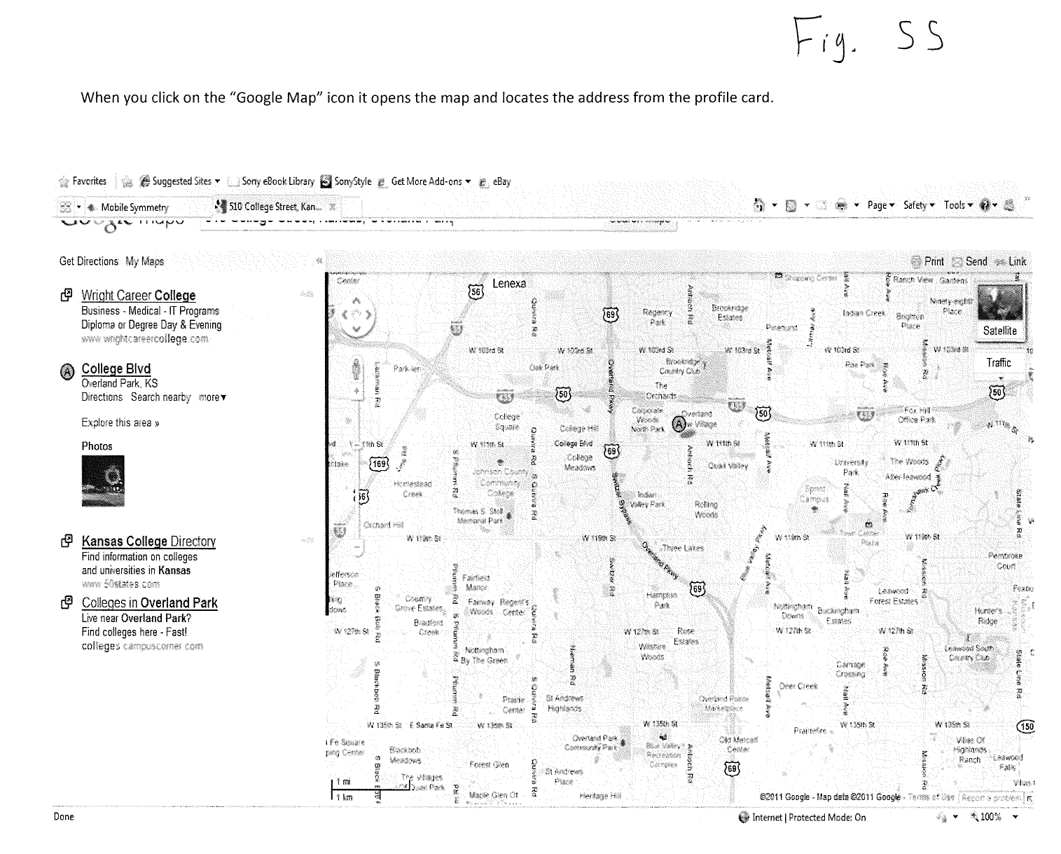

FIG. 39 is an exemplary screen shot that may be displayed by a computer, mobile communication device, or other electronic device while implementing one of the methods of the present invention and/or the computer programs of the present invention.

FIG. 40 is an exemplary screen shot that may be displayed by a computer, mobile communication device, or other electronic device while implementing one of the methods of the present invention and/or the computer programs of the present invention.

FIG. 41 is an exemplary screen shot that may be displayed by a computer, mobile communication device, or other electronic device while implementing one of the methods of the present invention and/or the computer programs of the present invention.

FIG. 42 is an exemplary screen shot that may be displayed by a computer, mobile communication device, or other electronic device while implementing one of the methods of the present invention and/or the computer programs of the present invention.

FIG. 43 is an exemplary screen shot that may be displayed by a computer, mobile communication device, or other electronic device while implementing one of the methods of the present invention and/or the computer programs of the present invention.

FIG. 44 is an exemplary screen shot that may be displayed by a computer, mobile communication device, or other electronic device while implementing one of the methods of the present invention and/or the computer programs of the present invention.

FIG. 45 is an exemplary screen shot that may be displayed by a computer, mobile communication device, or other electronic device while implementing one of the methods of the present invention and/or the computer programs of the present invention.

FIG. 46 is an exemplary screen shot that may be displayed by a computer, mobile communication device, or other electronic device while implementing one of the methods of the present invention and/or the computer programs of the present invention.

FIG. 47 is an exemplary screen shot that may be displayed by a computer, mobile communication device, or other electronic device while implementing one of the methods of the present invention and/or the computer programs of the present invention.

FIG. 48 is an exemplary screen shot that may be displayed by a computer, mobile communication device, or other electronic device while implementing one of the methods of the present invention and/or the computer programs of the present invention.

FIG. 49 is an exemplary screen shot that may be displayed by a computer, mobile communication device, or other electronic device while implementing one of the methods of the present invention and/or the computer programs of the present invention.

FIG. 50 is an exemplary screen shot that may be displayed by a computer, mobile communication device, or other electronic device while implementing one of the methods of the present invention and/or the computer programs of the present invention.

FIG. 51 is an exemplary screen shot that may be displayed by a computer, mobile communication device, or other electronic device while implementing one of the methods of the present invention and/or the computer programs of the present invention.

FIG. 52 is an exemplary screen shot that may be displayed by a computer, mobile communication device, or other electronic device while implementing one of the methods of the present invention and/or the computer programs of the present invention.

FIG. 53 is an exemplary screen shot that may be displayed by a computer, mobile communication device, or other electronic device while implementing one of the methods of the present invention and/or the computer programs of the present invention.

FIG. 54 is an exemplary screen shot that may be displayed by a computer, mobile communication device, or other electronic device while implementing one of the methods of the present invention and/or the computer programs of the present invention.

FIG. 55 is an exemplary screen shot that may be displayed by a computer, mobile communication device, or other electronic device while implementing one of the methods of the present invention and/or the computer programs of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

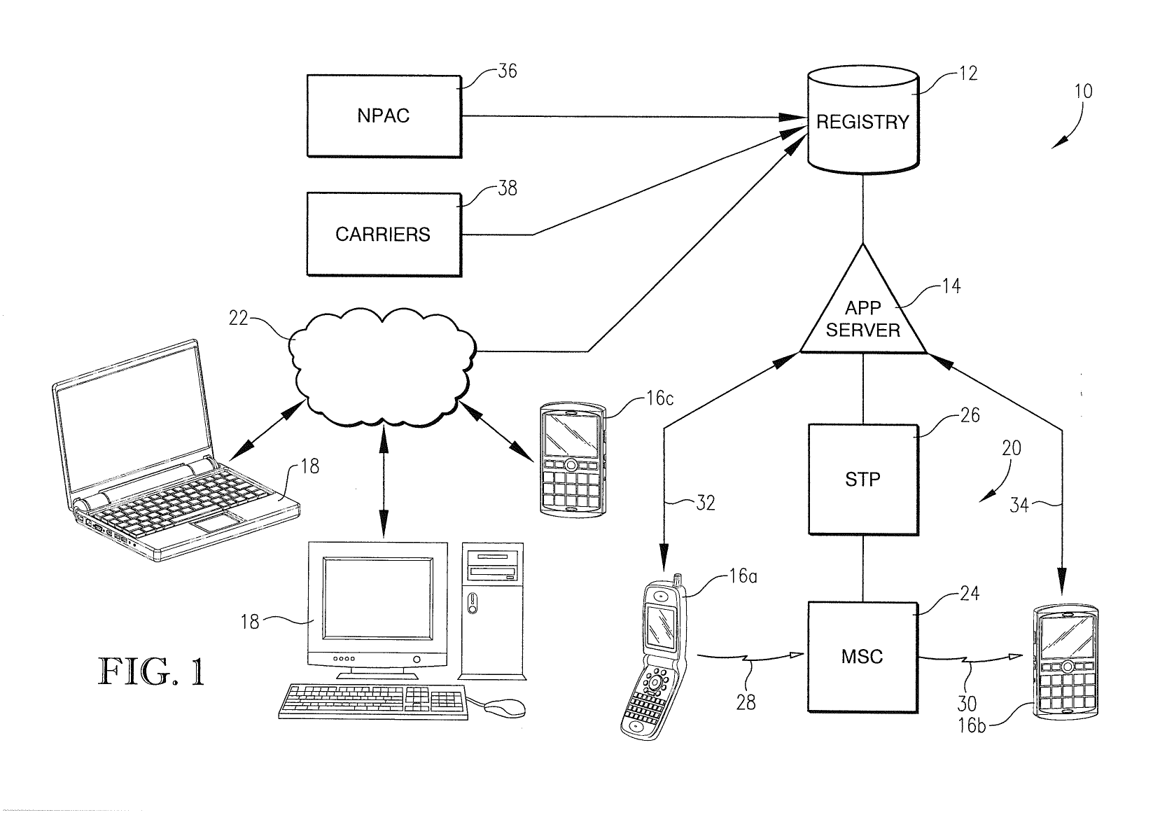

Embodiments of the present invention can be implemented in hardware, software, firmware, or a combination thereof. In one embodiment, the invention is implemented with computer and communications equipment broadly referred to by the numeral 10 in FIG. 1. The computer and communications equipment 10 includes a central registry 12, one or more application servers 14, a plurality of mobile communications devices 16, one or more computing devices 18, a wireless telecommunications network 20, and a communications network 22. The components of the computer and communication equipment 10 illustrated and described herein are merely examples of equipment that may be used to implement embodiments of the present invention and may be replaced with other equipment without departing from the scope of the present invention.

In more detail, the central registry 12 serves as a repository for user profiles and programs used to implement certain aspects of the present invention as described in more detail below. The central registry 12 may include one or more servers running Windows; LAMP (Linux, Apache HTTP server, MySQL, and PHP/Perl/Python); Java; AJAX; NT; Novel Netware; Unix; or any other software system and includes or has access to computer memory and other hardware and software for receiving, storing, accessing, and transmitting user profiles and related requests as described below. The central registry also includes conventional web hosting operating software, searching algorithms, an Internet connection, and is assigned a URL and corresponding domain name such as “mobilesymmetry.com” so that a website hosted thereon can be accessed via the Internet in a conventional manner.

The application servers 14 are provided to distribute the data stored on the central registry 12, if necessary, so that the central registry is not over-burdened with user profile requests and other functions. Thus, the number of application servers 14 required depends on the number of user profiles stored in the central registry 12 and the number of look-up requests and other requests received by the central registry 12. In some embodiments, many application servers 14 may be needed, and in other embodiments, only one or even no application servers 14 may be needed. As with the central registry 12, each application server 14 may include one or more servers running Windows NT, Novel Netware, Unix, or any other network operating system and includes or has access to computer memory and other hardware and software for receiving, storing, accessing, and transmitting user profiles and related requests as described below. Each application server 14 may also include conventional web hosting operating software, searching algorithms, an Internet connection, and a URL and corresponding domain name so that a website hosted thereon can be accessed via the Internet in a conventional manner. The application servers may also host and support software and services of proprietary mobile application providers such as Google, Apple, and Blackberry.

The mobile communication devices 16 may be any type of devices that can make and receive wireless communications such as phone calls, SMS texts, MMS messages, SMTP messages, etc. via the wireless telecommunication network 20. The mobile communication devices 16 may include, for example, wireless phones, phone-enabled personal digital assistants, phone-enabled MP3 devices, phone-enabled handheld game players, phone-enabled tablet computers, or any other wireless communication device. In current embodiments of the invention, the mobile communication devices are “smart” phones such as those manufactured by Apple®, Blackberry®, or Motorola®. Each mobile communication device 16 preferably includes or can access an Internet browser and a conventional Internet connection such as a wireless broadband connection, a modem, DSL converter, or ISDN converter so that it can access the central registry 12 via the communications network 22.

Any number of mobile communication devices 16 may use the directory services of the present invention. For simplicity only three mobile communication devices are shown in FIG. 1, a mobile communication device 16a that submits a look-up request to the registry 12 and makes a phone call, a mobile communication device 16b that receives the phone call from the mobile communication device 16a and submits a query to the registry, and a mobile communication device 16c that submits information and look-up requests to the registry via the communication network 22.

The computing devices 18 may be any devices that can access the central registry 12 via the communications network 22. For example, the computing devices may be laptop, desktop, tablet or other personal computers such as those manufactured by Macintosh®, Dell®, or Toshiba®. As with the mobile communication devices 16, each computing device 18 includes or can access an Internet browser and a conventional Internet connection such as a wireless broadband connection, a modem, DSL converter, or ISDN converter so that it can access the central registry via the communications network.

The wireless telecommunication network 20 may be any communication network capable of supporting wireless communications between the mobile communication devices 16 such as the wireless networks operated by AT&T, Verizon, or Sprint. The wireless telecommunication network 20 includes conventional switching and routing equipment, but for simplicity, only a mobile switching center (MSC) 24 and signal transfer point (STP) 26 serving a terminating or called mobile communication device are illustrated in FIG. 1.

The wireless telecommunication network 20 establishes voice channels 28, 30 between the mobile communications devices 16a, 16b and the MSC 24 and data channels 32, 34 between the mobile communication devices 16a, 16b and the registry 12.

The communications network 22 is preferably the Internet but may be any other communications network such as a local area network, a wide area network, a wireless network, or an intranet. The communications network 22 may also be a combination of several networks.

The computer programs of the present invention are stored in or on computer-readable medium residing on or accessible by the registry 12, and the mobile communication devices 16. One embodiment of the invention includes one or more computer programs that implement functions and features of the invention on the registry 12 and a client software application that may be loaded on some or all of the mobile communication devices 16 for implementing functions and features of the invention on the mobile communication devices.

The computer programs preferably comprise ordered user profiles of executable instructions for implementing logical functions in their respective devices. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The above-described computer and communications equipment 10 and computer programs may be used to provide cross-carrier directory service features for mobile communication device users as described in detail in U.S. patent application Ser. No. 12/901,095, entitled METHOD AND SYSTEM FOR PROVIDING CONTACT INFORMATION FOR MOBILE COMMUNICATION DEVICE USERS, (referred to herein as the “'095 Application”) which is hereby incorporated by reference in its entirety. In general, the registry 12 stores a plurality of user profiles, wherein each user profile is established and maintained by one of the users of the mobile communication devices 16 or computing devices 18. Each user profile includes, among other information, a user's name and phone number and permission information that enables the user to select how and by whom they are contacted. In some embodiments, each user profile serves as a repository of all contact addresses and methods for the user including mobile phone numbers, landline phone numbers, email addresses, Skype addresses, Facetime, Fringe, Qik, etc.

The above-described computer and communications equipment 10 and computer programs may also be used to create and administer group directories such as contact lists for members of church groups, sports terms, clubs, etc. Any adult with a user profile in the registry 12 may access the registry 12 or another computer system in communication with the registry and create a group directory. The user who creates the group directory, referred to herein as the “administrator”, provides the names of desired members, and the registry 12 or another computer system sends invitations to them. When a member accepts the invitation, his or her user profile in the registry is linked to the group directory as explained in more detail below. Group members may invite others to join the group directory whether the invited persons have a user profile in the registry or not. For public group directories, users who have a user profile in the registry may request to join the group directory. In both examples, the administrator must approve the requests to join.

Each person with a user profile in the registry may create different profiles and then designate who can access each profile as explained in detail in the '095 Application referenced above. For example, a user profile may include a public profile that can be viewed by anyone with access to the registry, a private profile that can only be viewed by designated people, and a business profile that can be viewed by other designated people. When a member accepts an invitation to join a group directory, he or she may pick which profile to be included in the directory as explained in more detail below. This permits users to join many different group directories and to pick which profile is the most appropriate for each.

Once a group directory is created, the administrator or another group member authorized by the administrator may access the registry and create a message to be sent to the members. When an administrator initiates a message, the registry accesses the user profiles of all the members designated to receive the message and then assembles and renders the message into the format required by each member's user profile. For example, the registry may send an email to one member, a test message to another, a computer-generated voicemail message to yet another, a Skype message to another, and/or a combination of messages to another.

Importantly, the registry of user profiles and all other features of the present invention follow guidelines of the Children's Online Privacy Protection Act (COPPA) and similar pending proposals for children and minors (children are under 13 years of age, minors are 13 or older and under 18). All child and minor profile information is protected starting with the initial requests for information from the child/minor, through the gathering of the information, and to the storing and access of the information. For example, a child is only allowed to have a private view as defined below, whereas a minor may have a public view and a private view. For a child profile, one or more responsible adults must be designated, and the responsible adult(s) must approve the child's profile before it is posted, all views of the profile, which directories the child opts into, and any changes to the profile. Similar protections are provided for minor profiles, except with a minor profile, the responsible adult(s) may approve the initial profile and then may elect to either approve all profile changes and directory access or just be notified of the same.

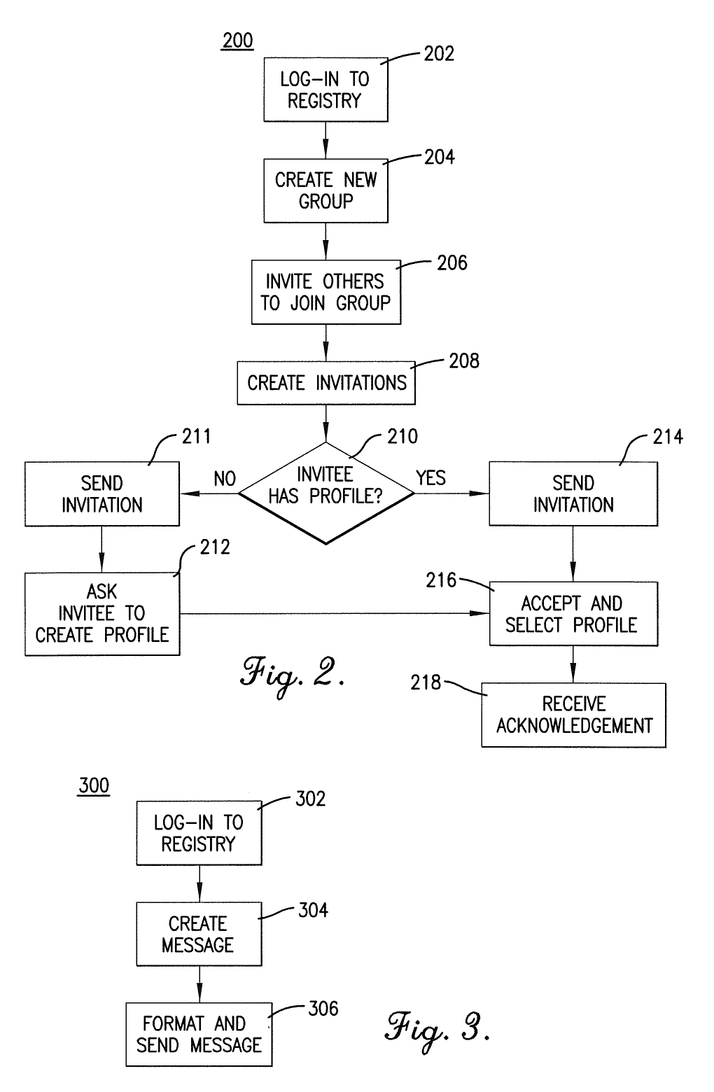

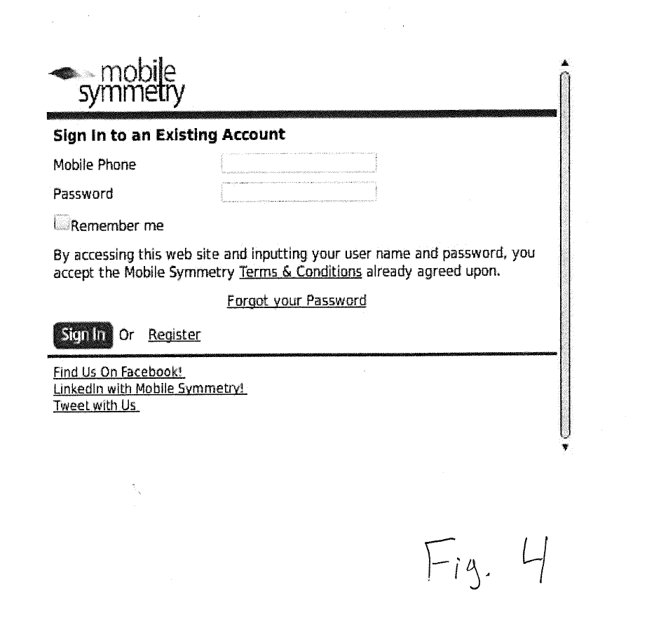

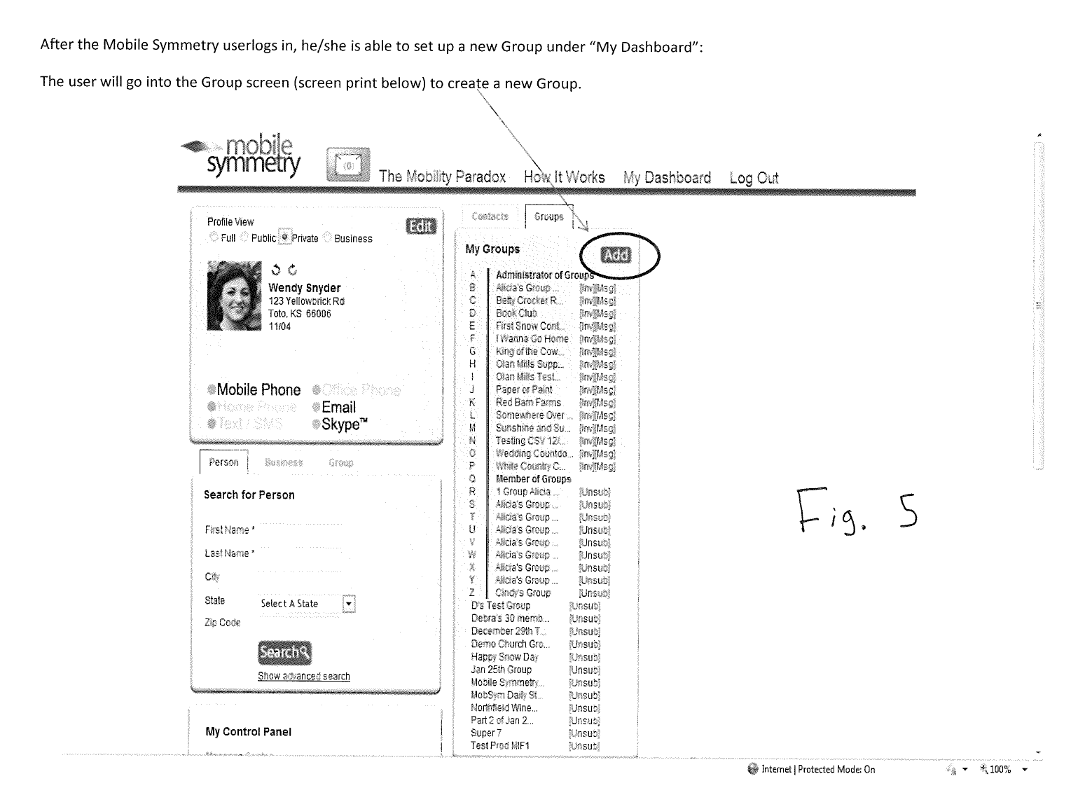

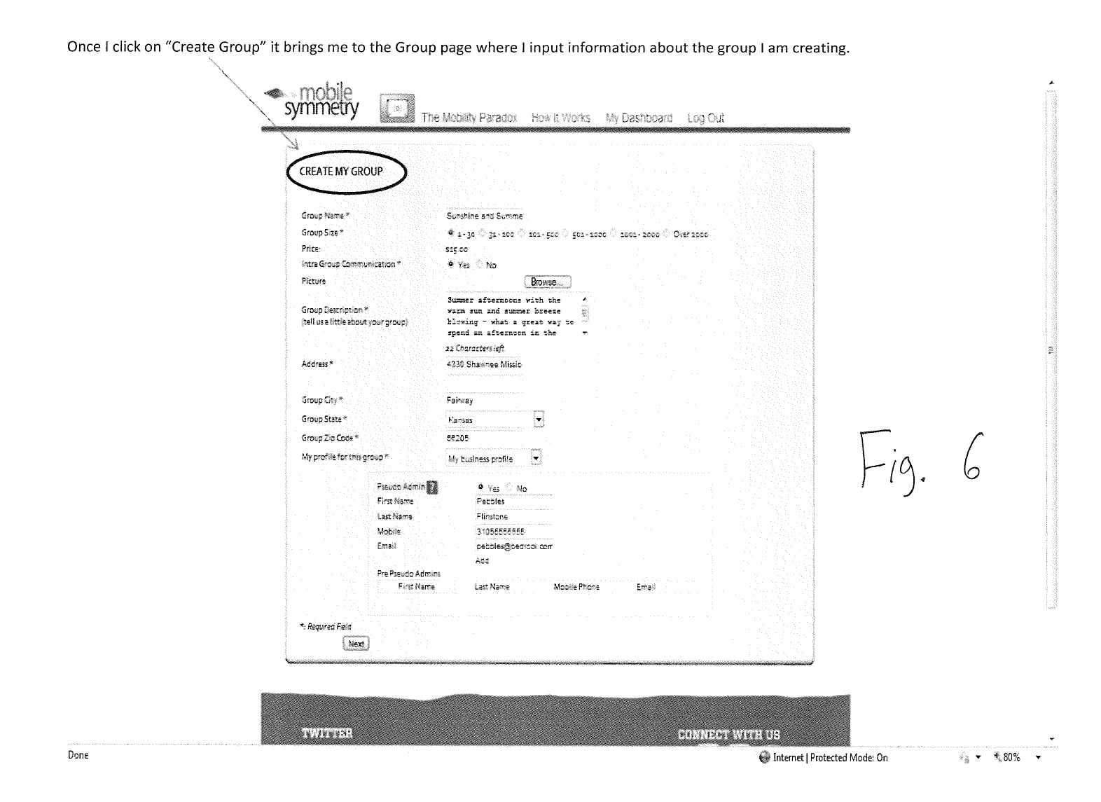

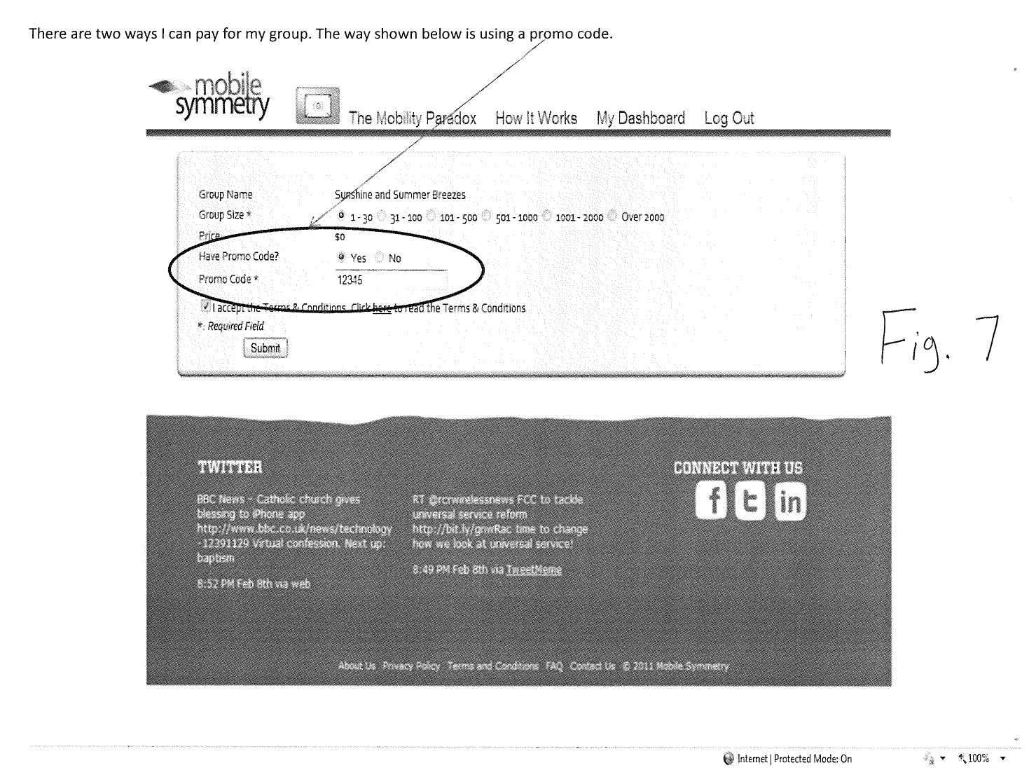

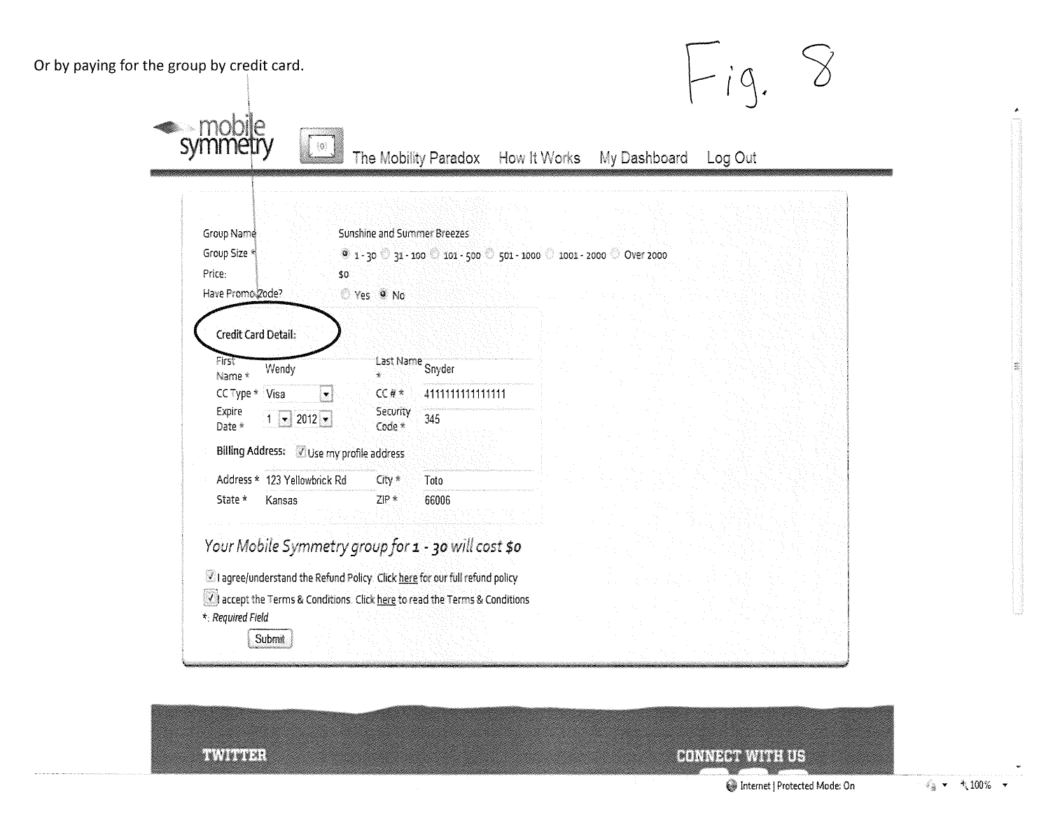

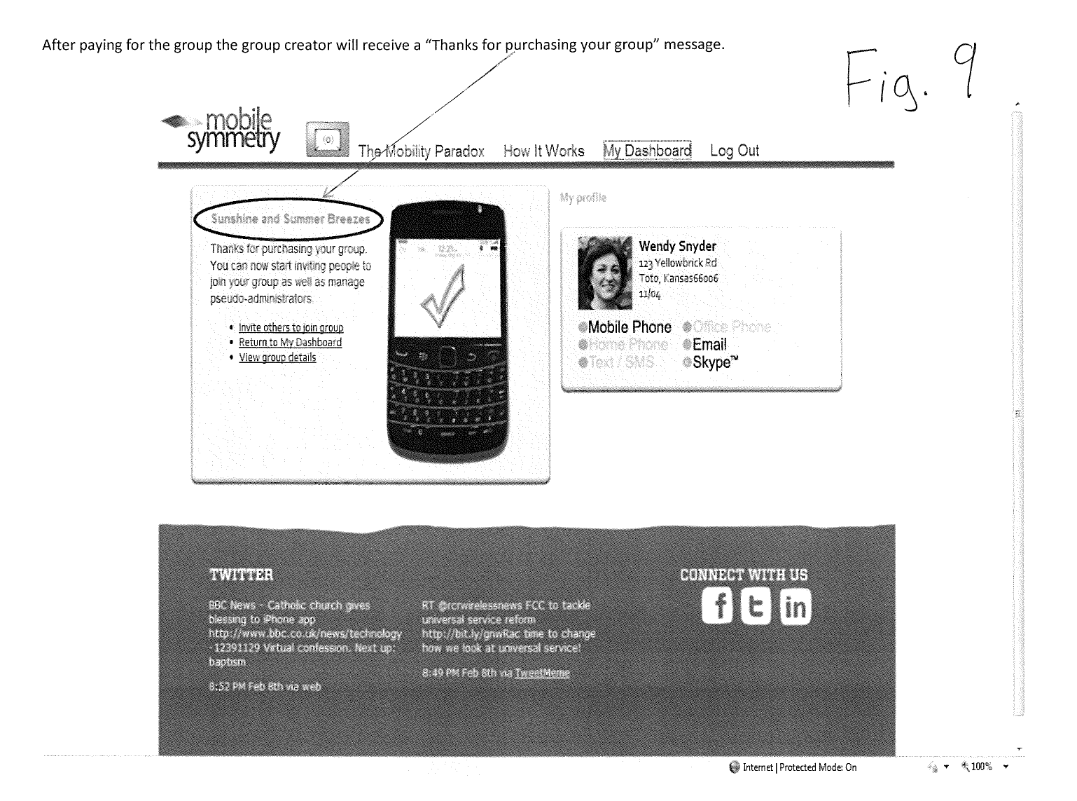

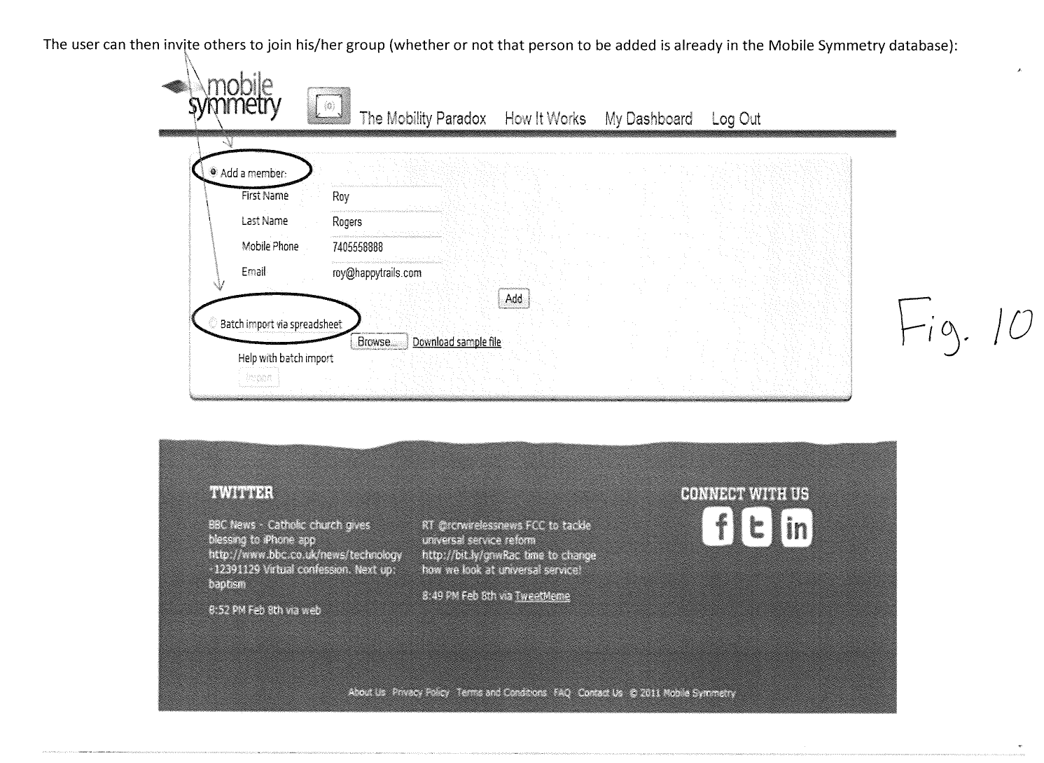

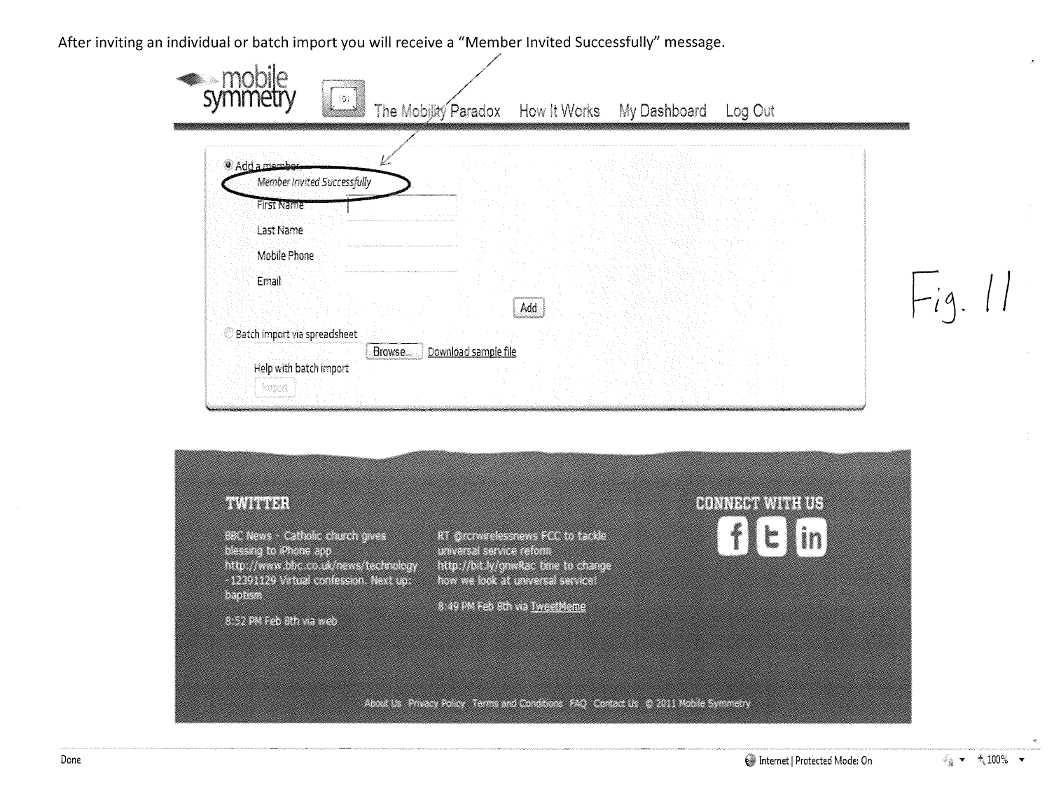

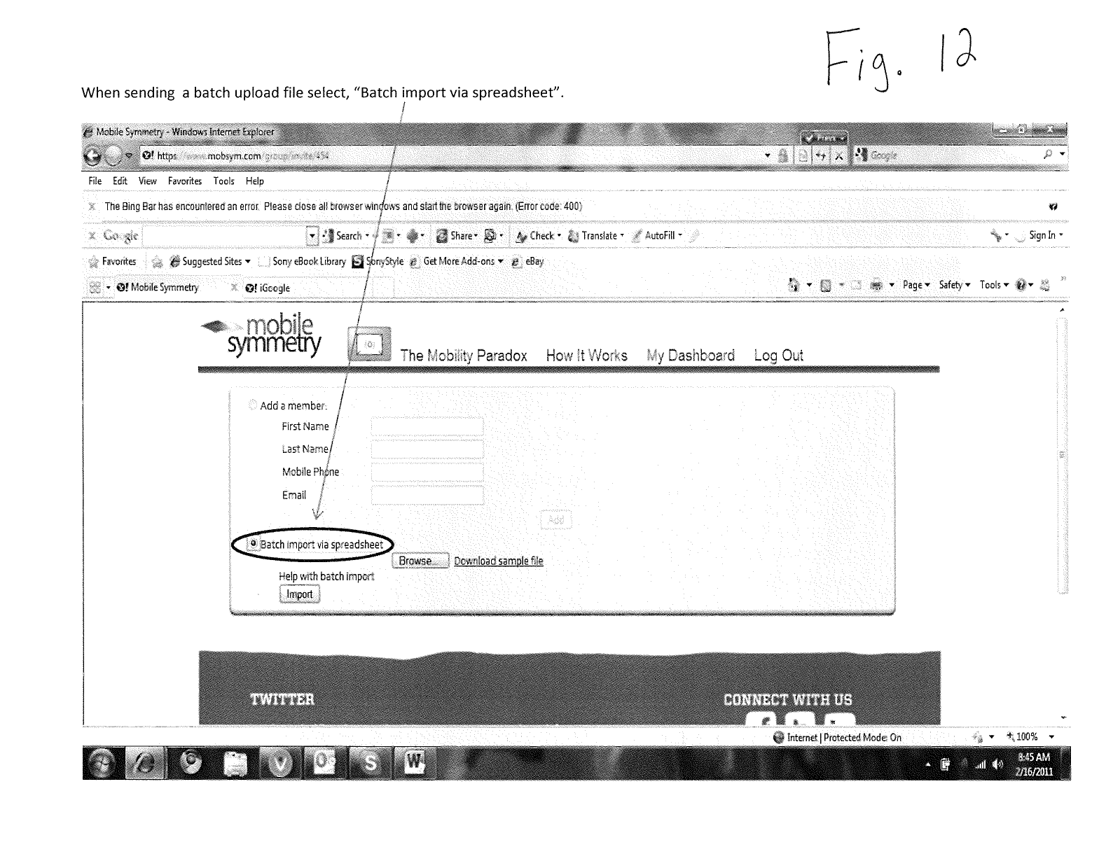

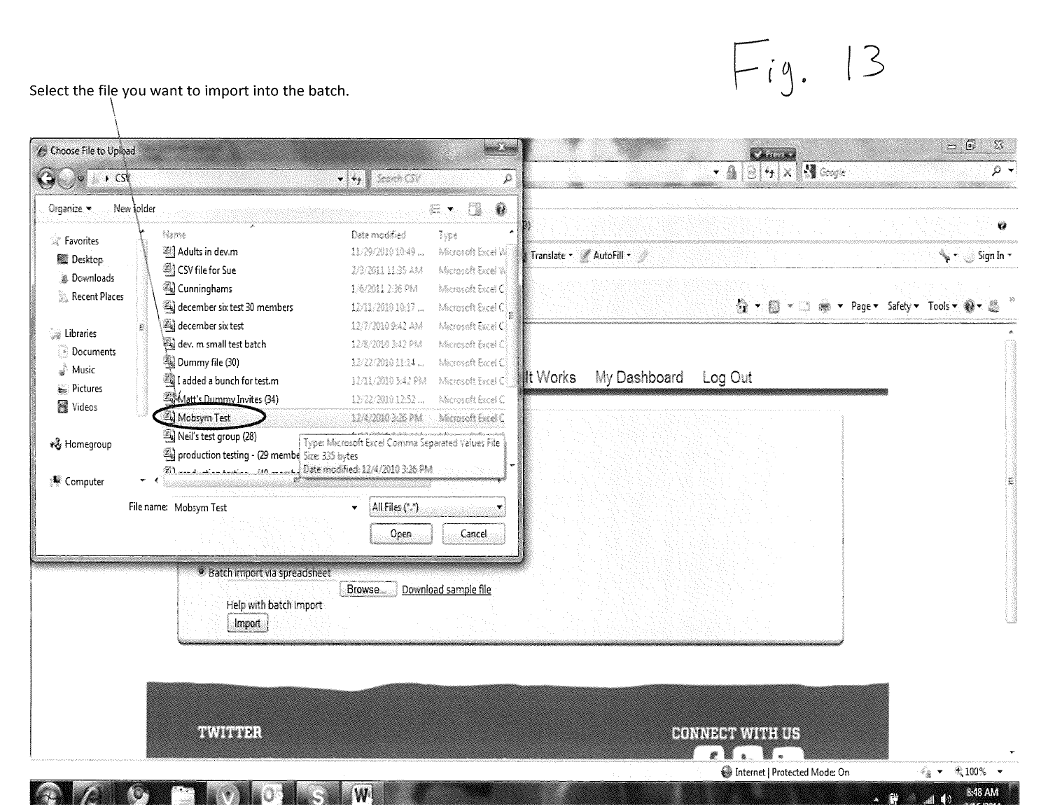

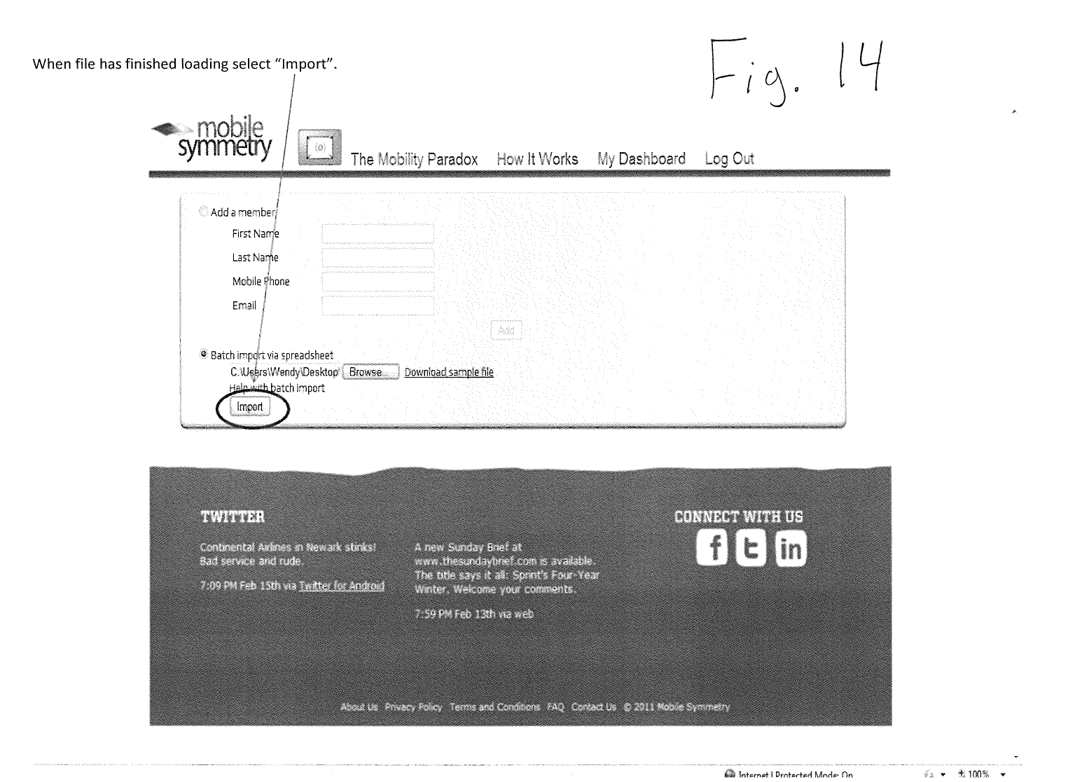

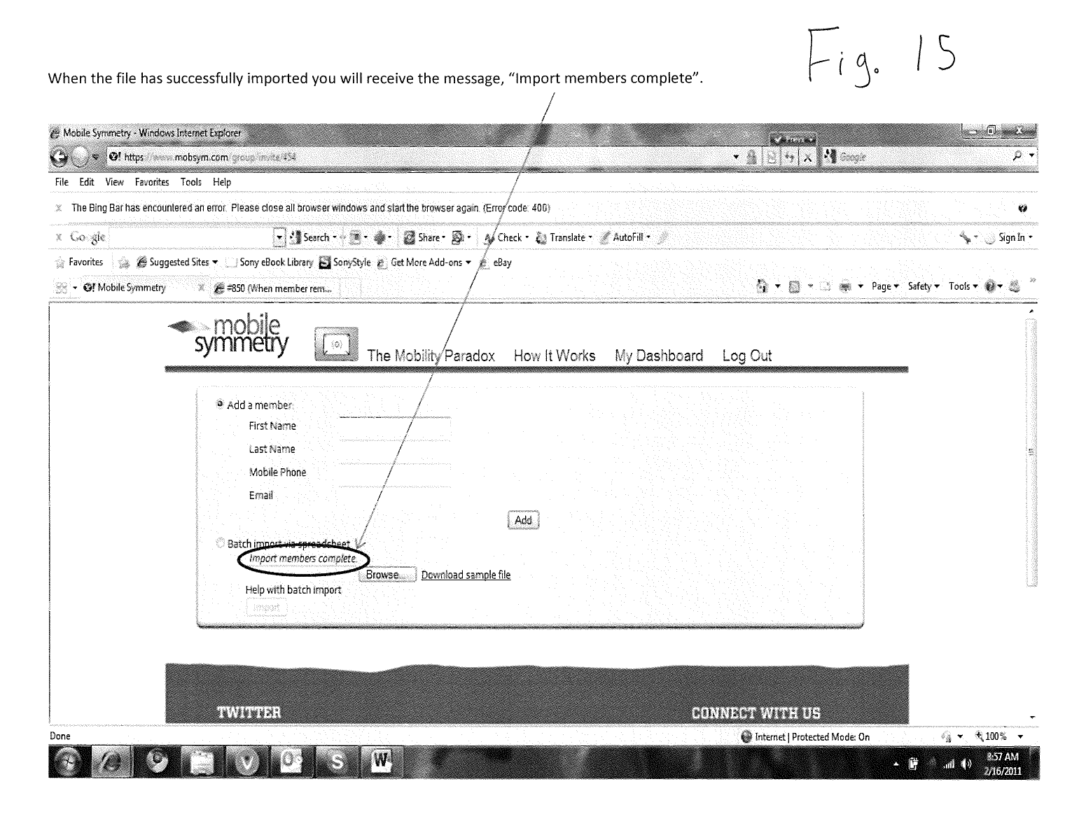

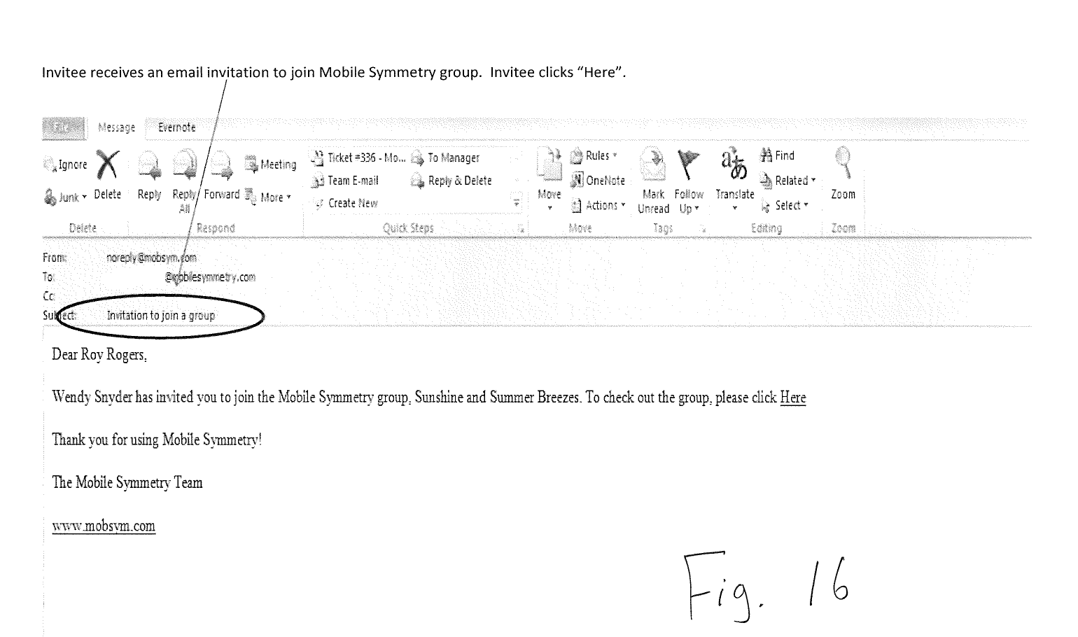

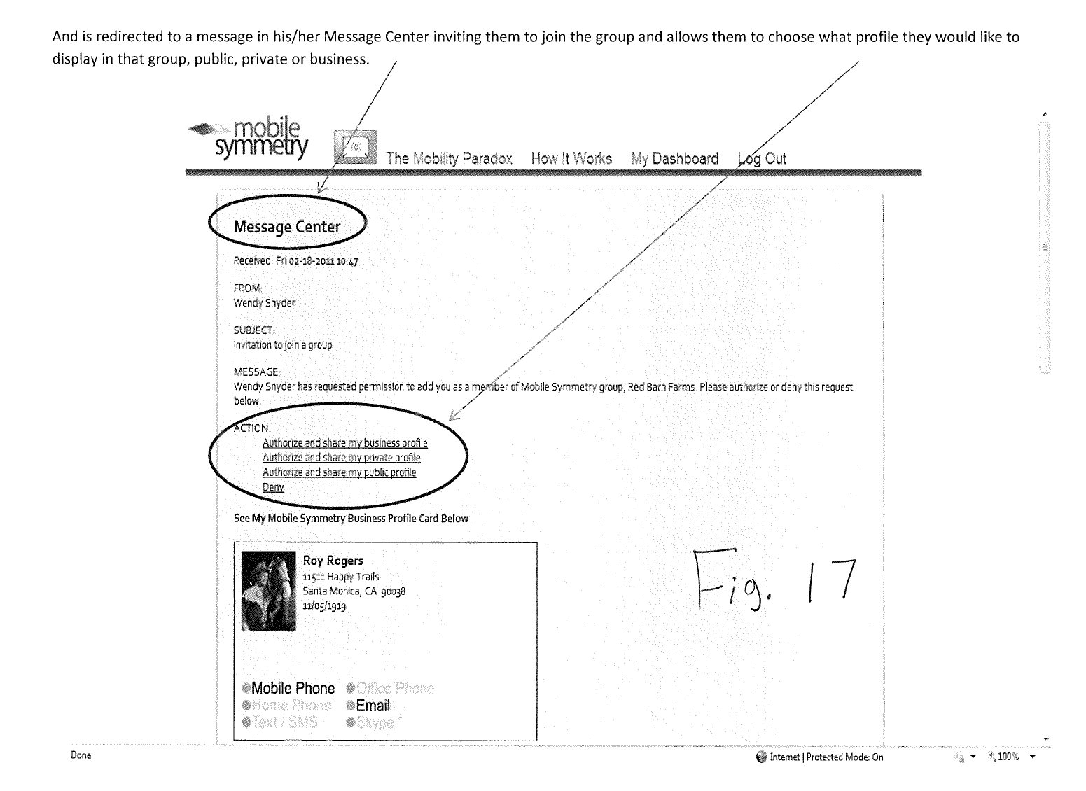

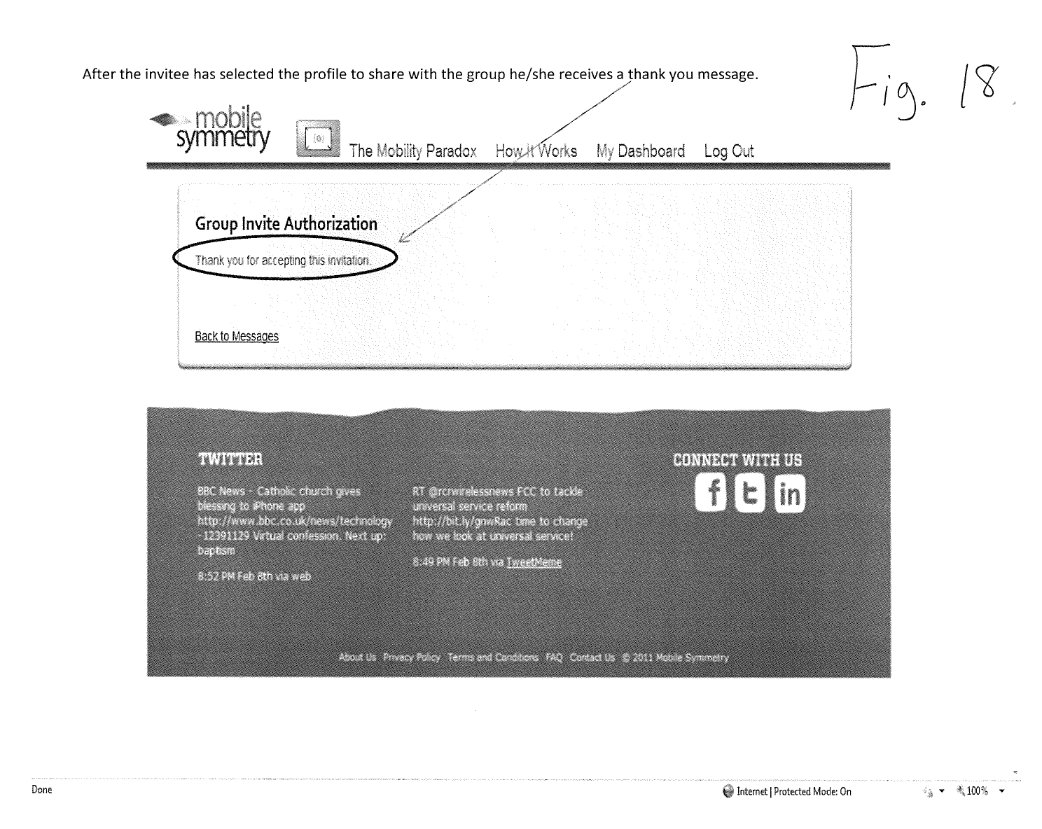

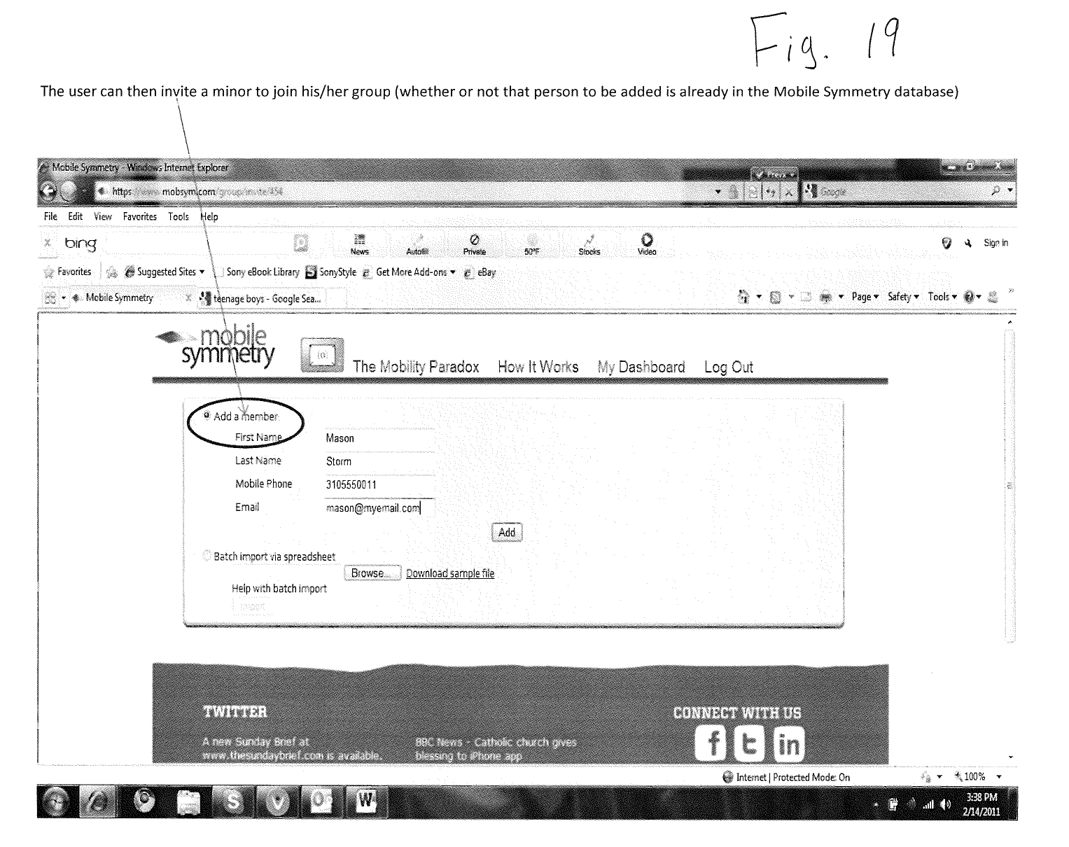

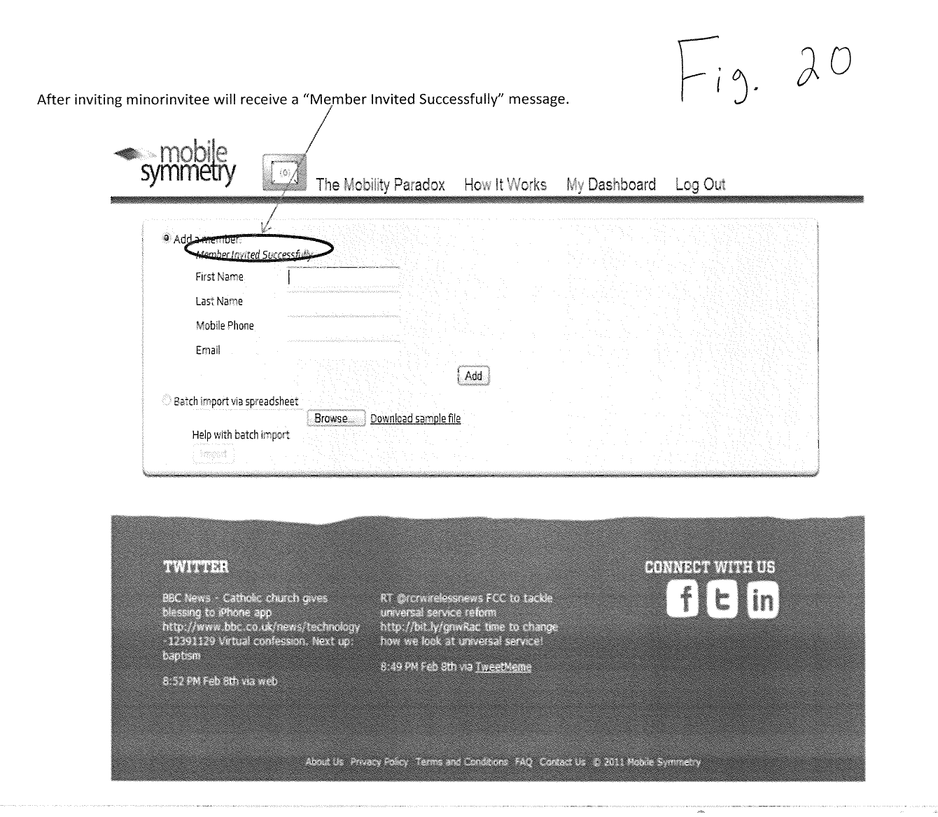

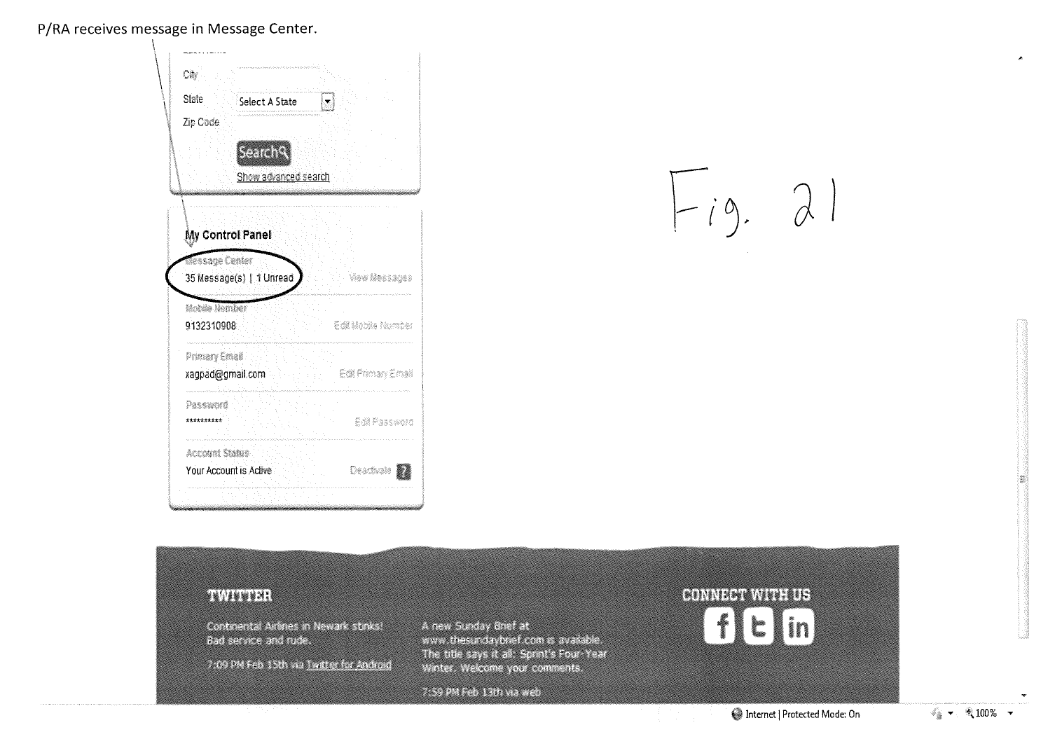

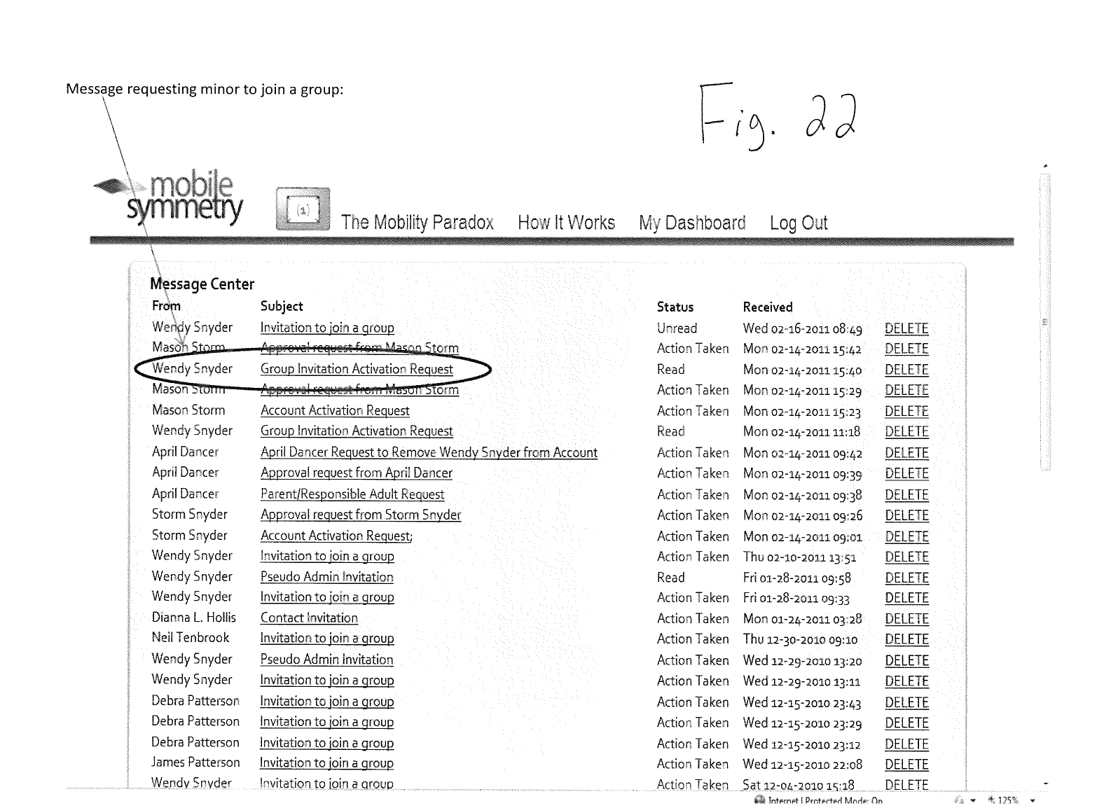

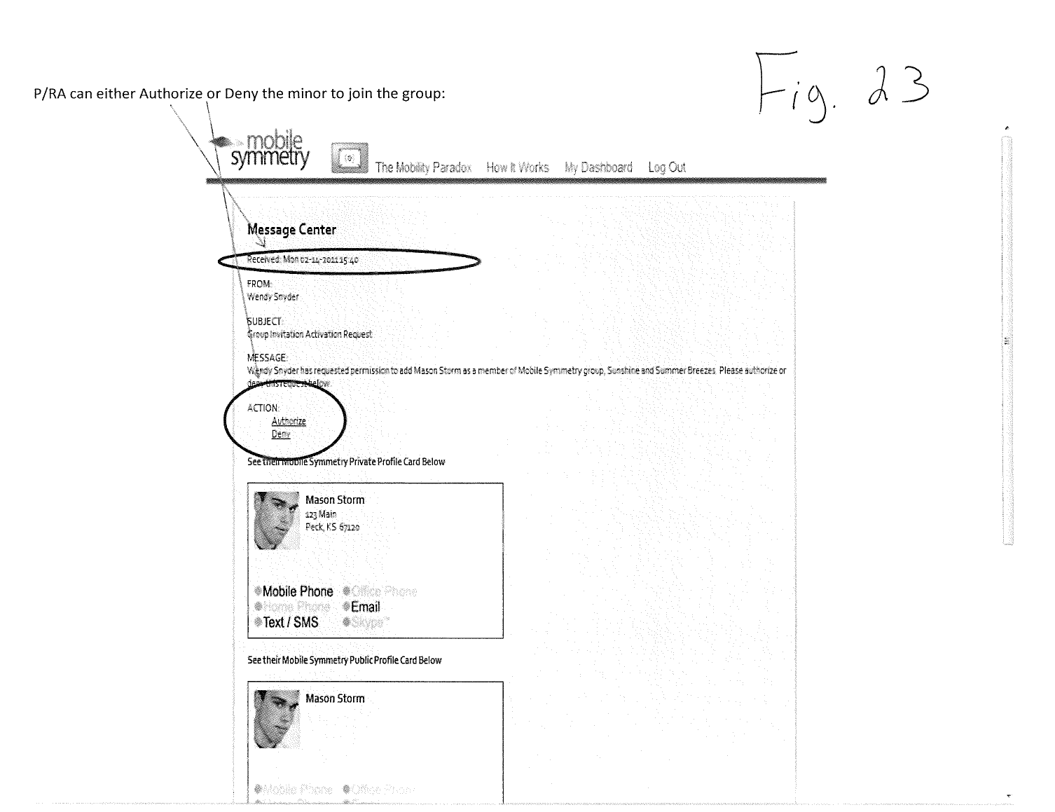

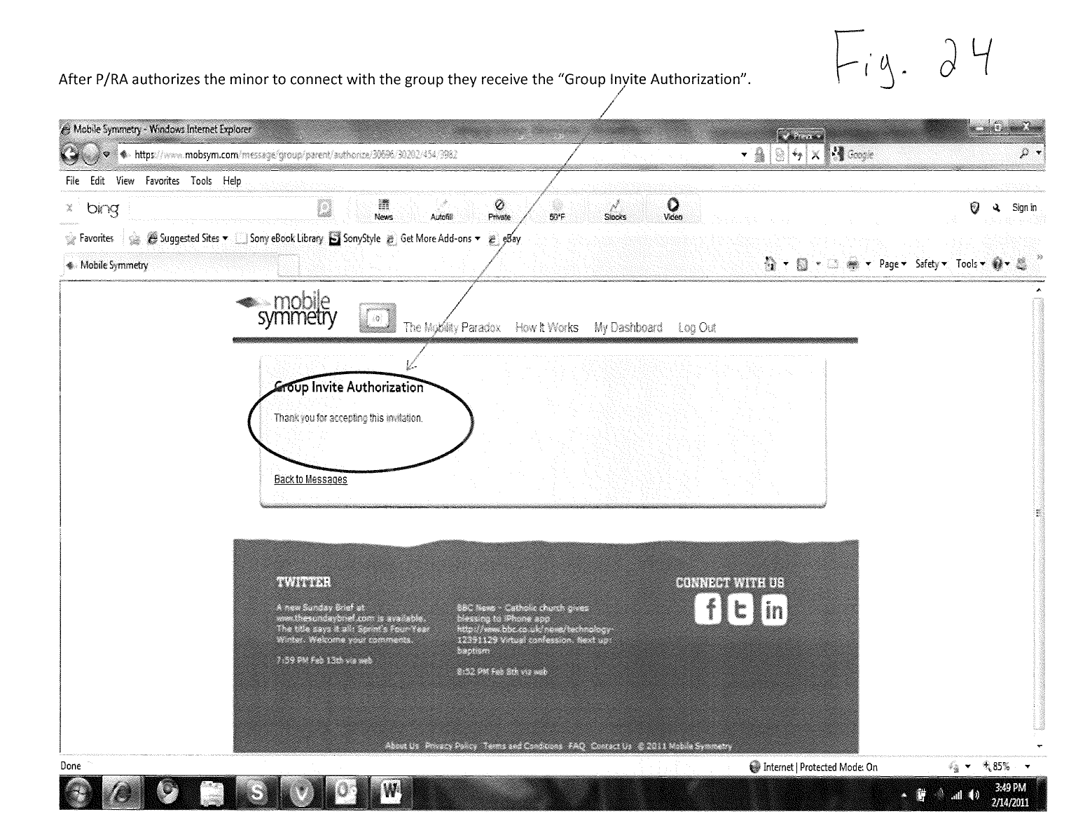

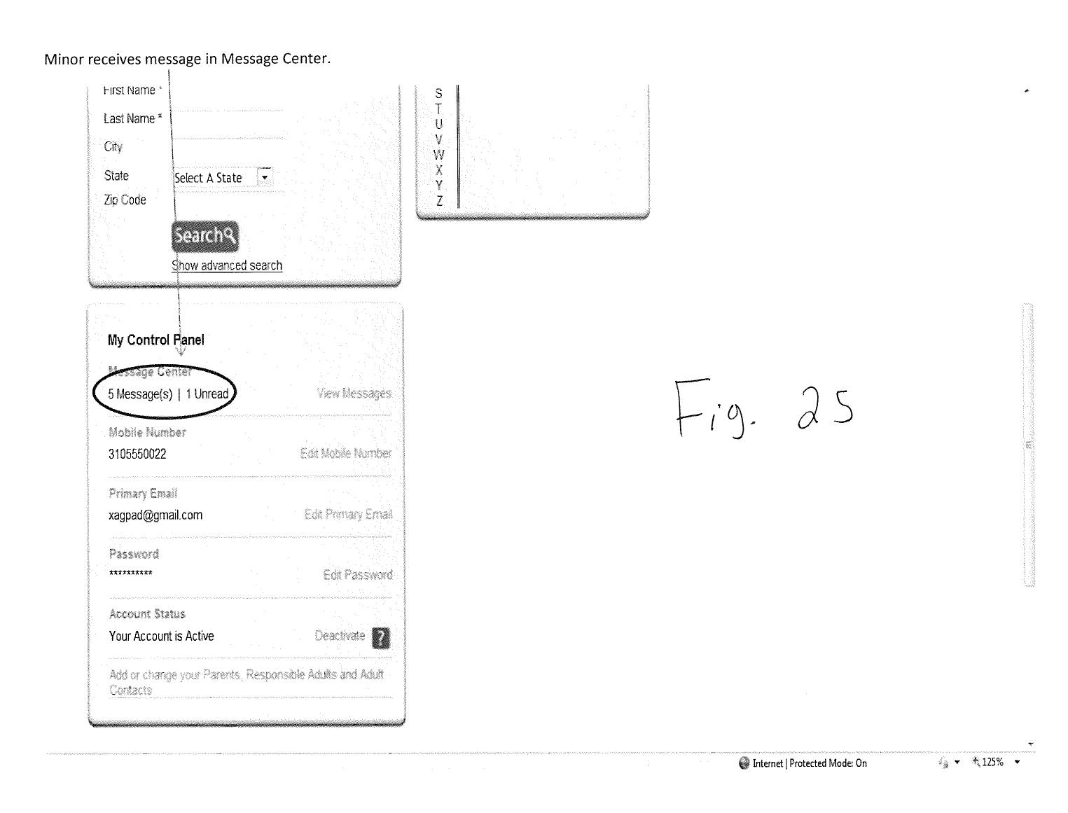

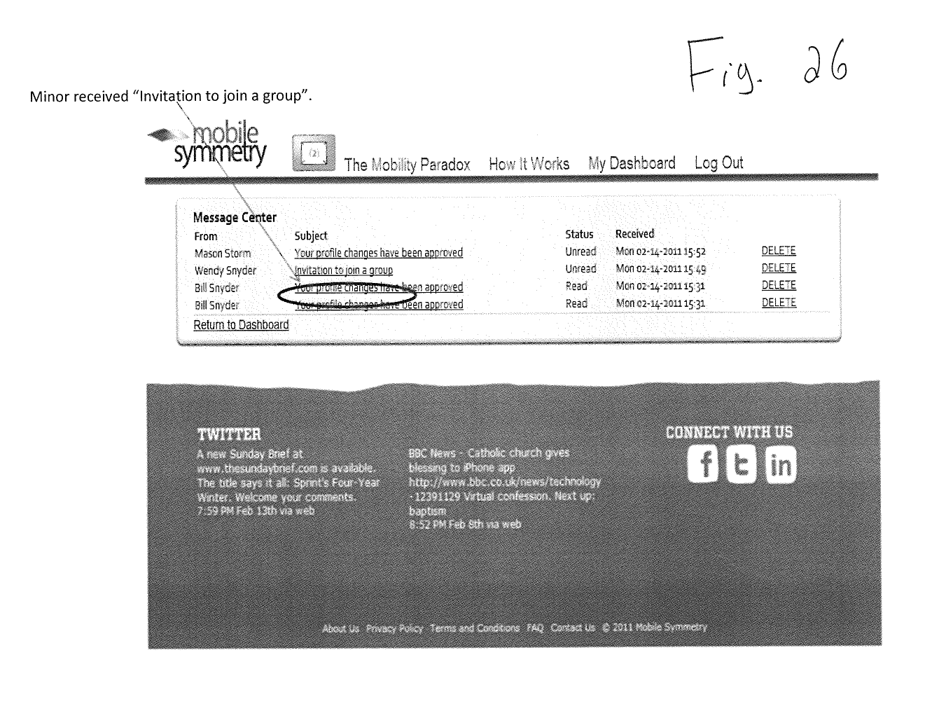

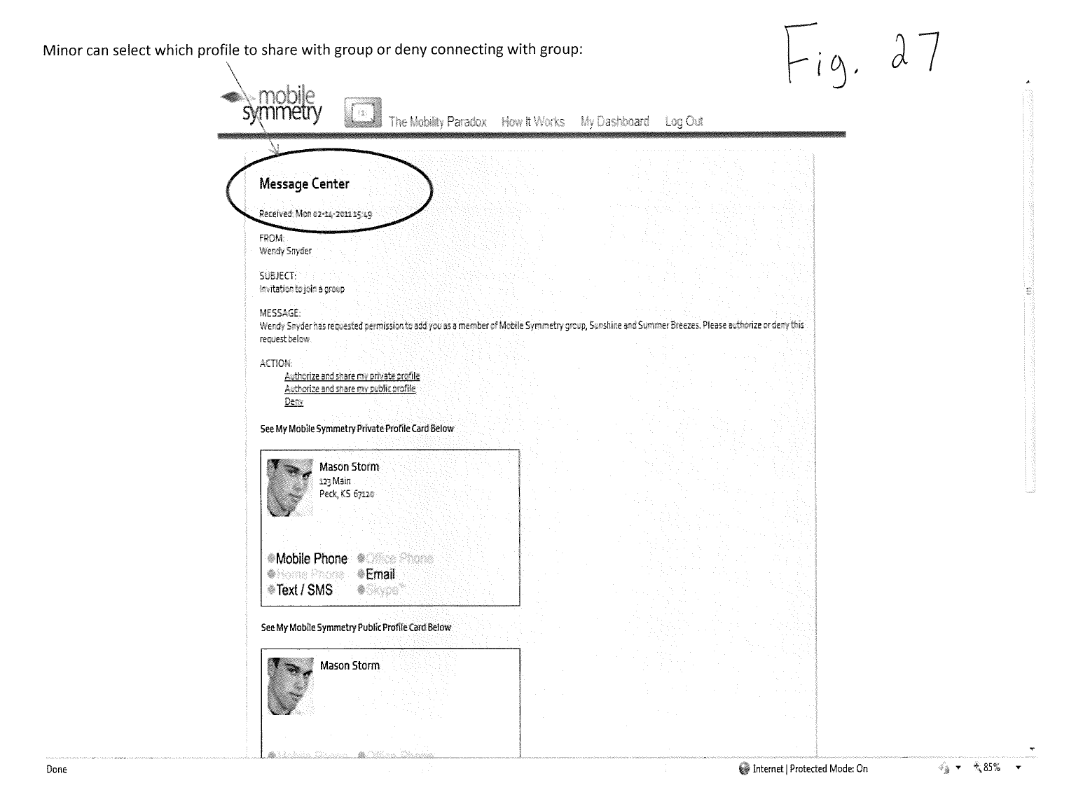

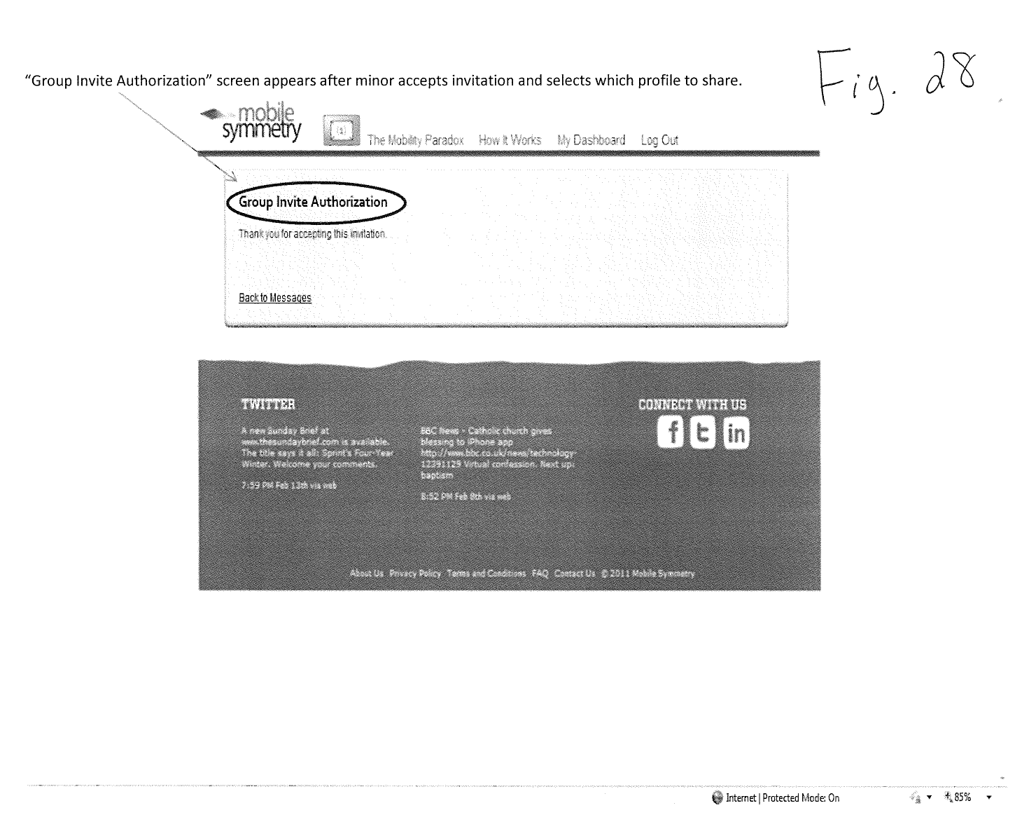

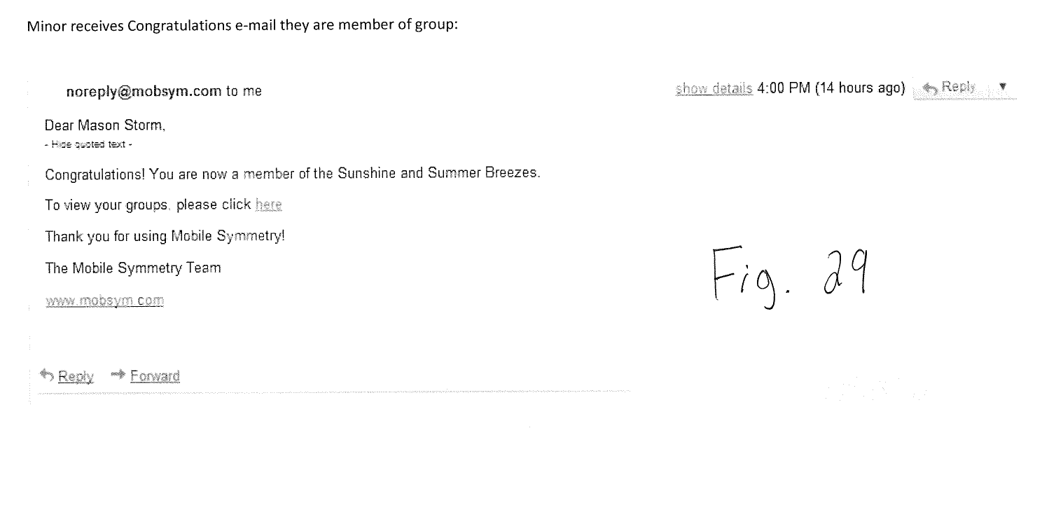

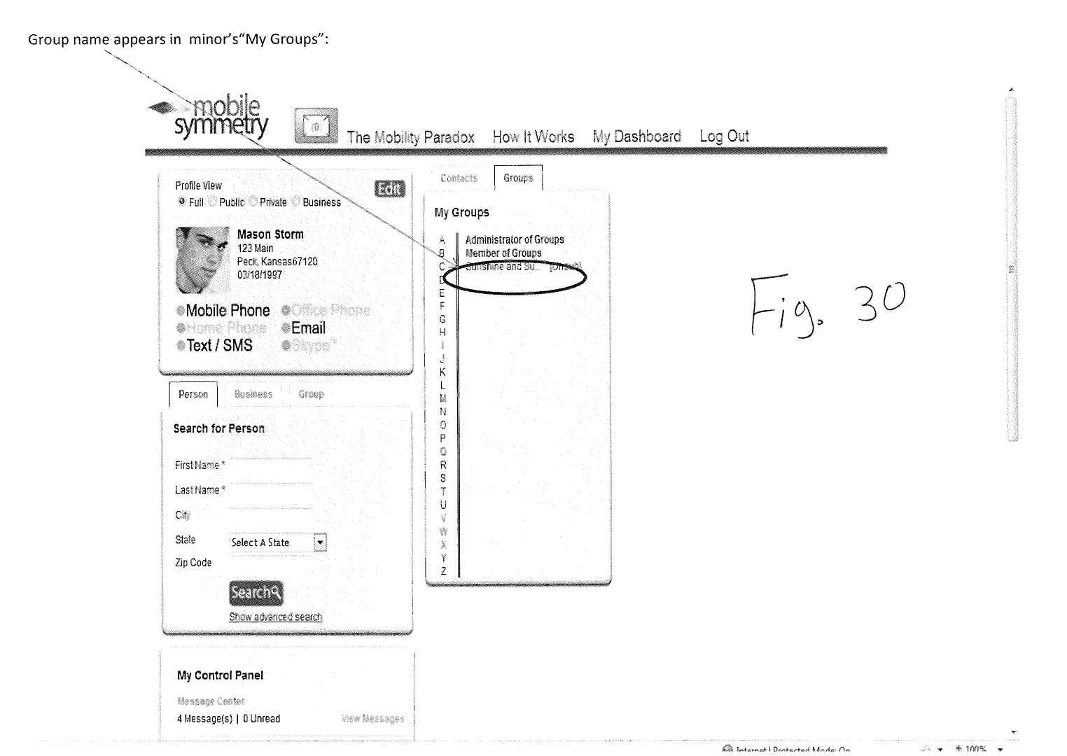

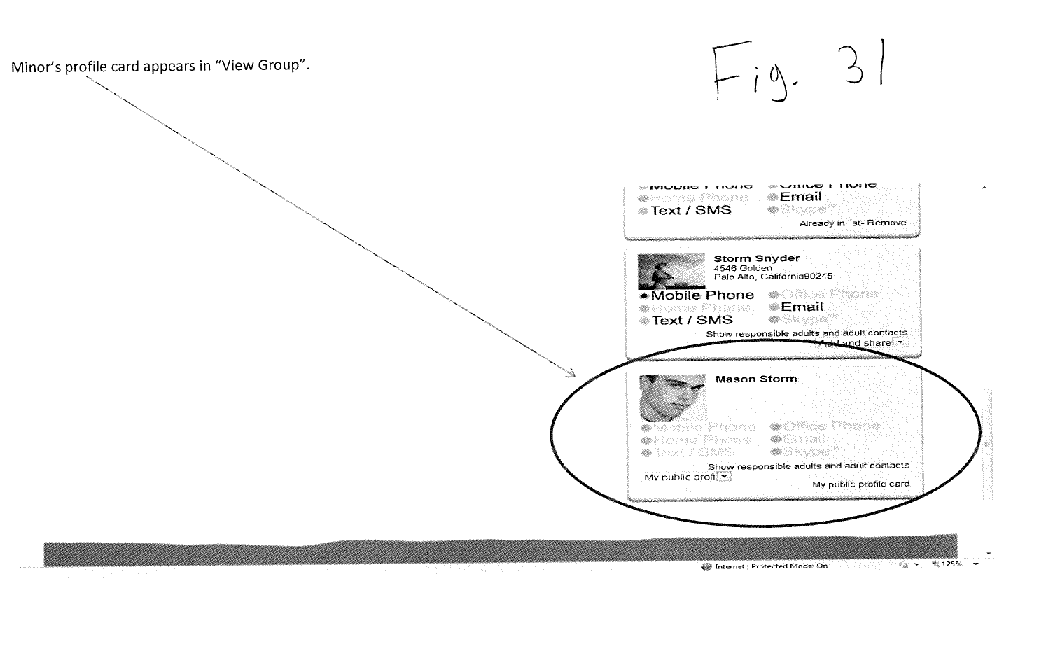

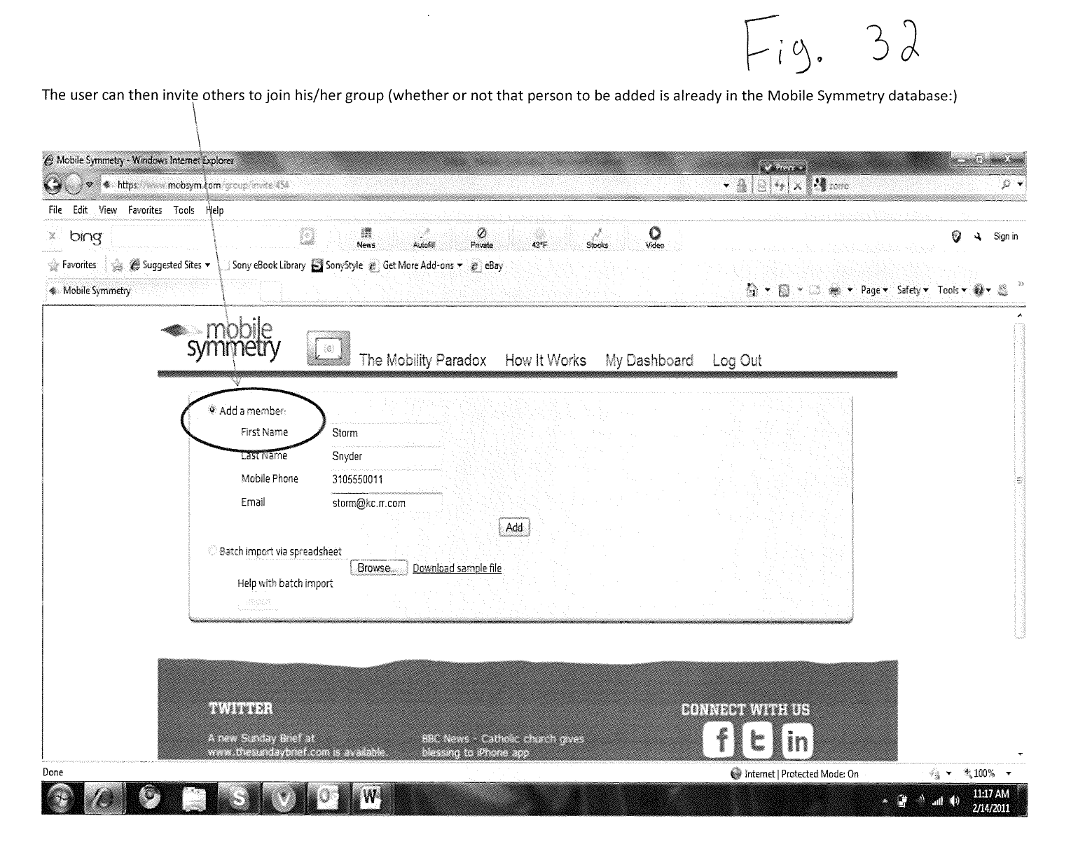

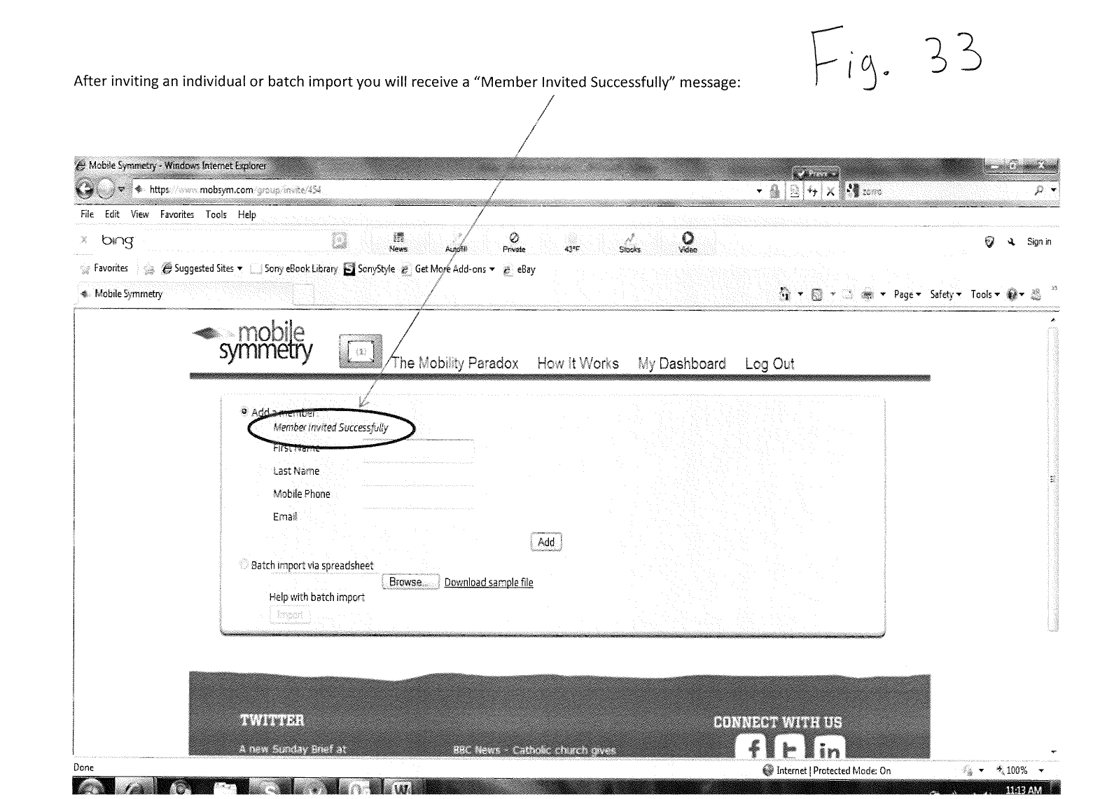

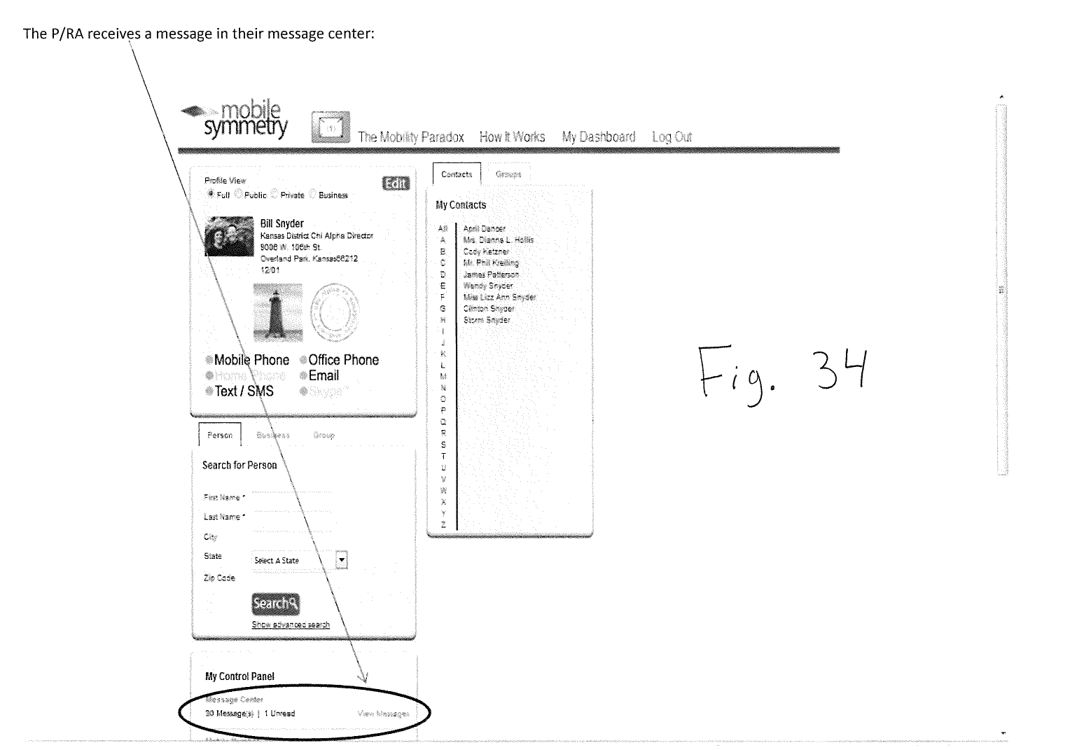

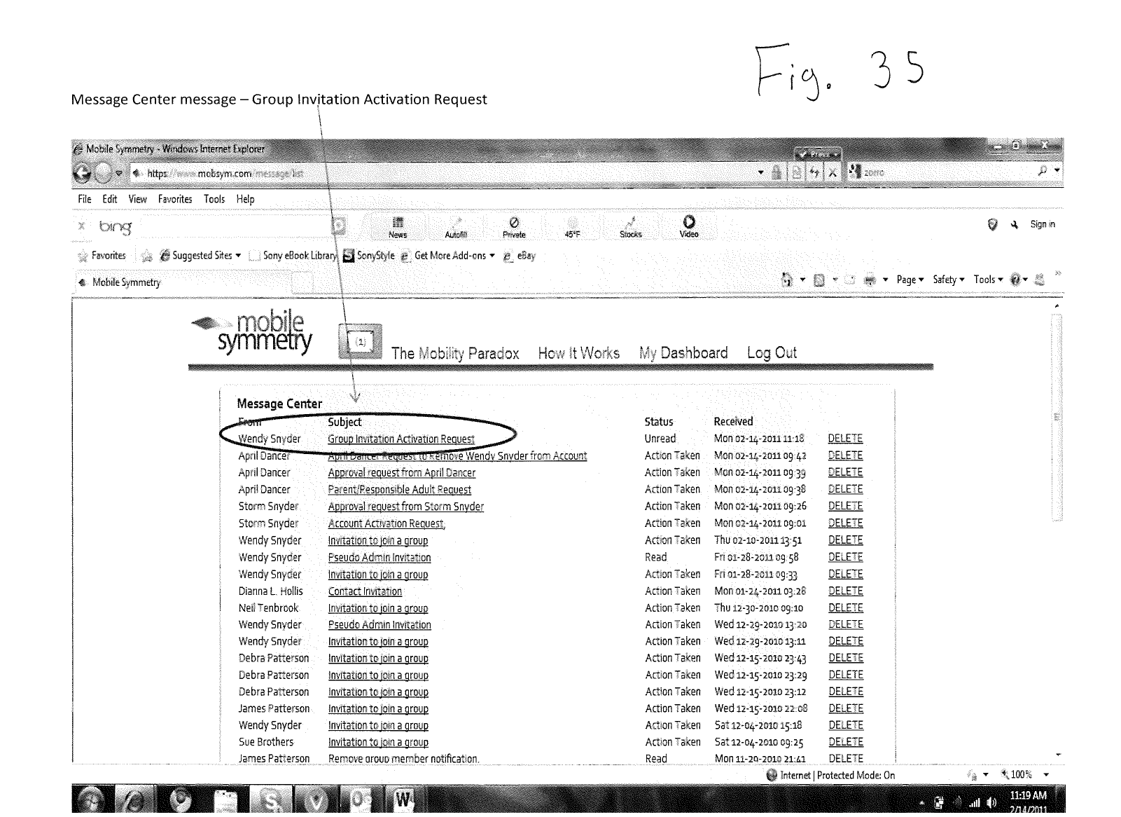

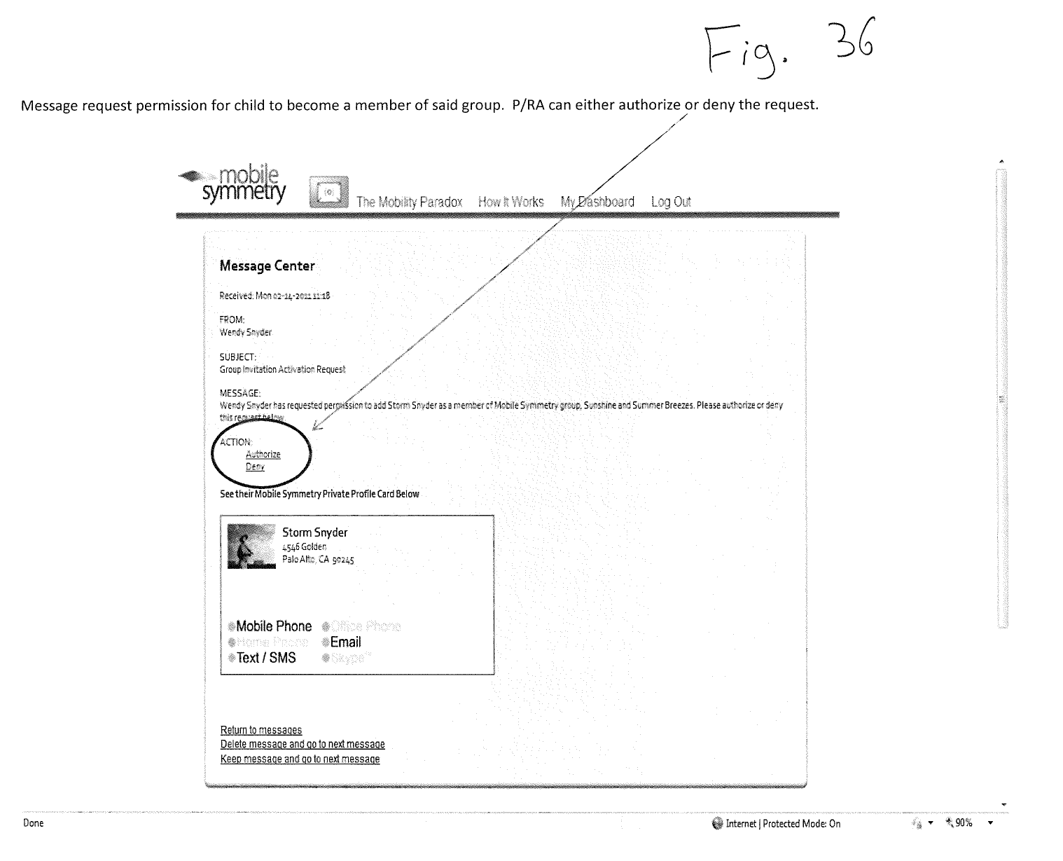

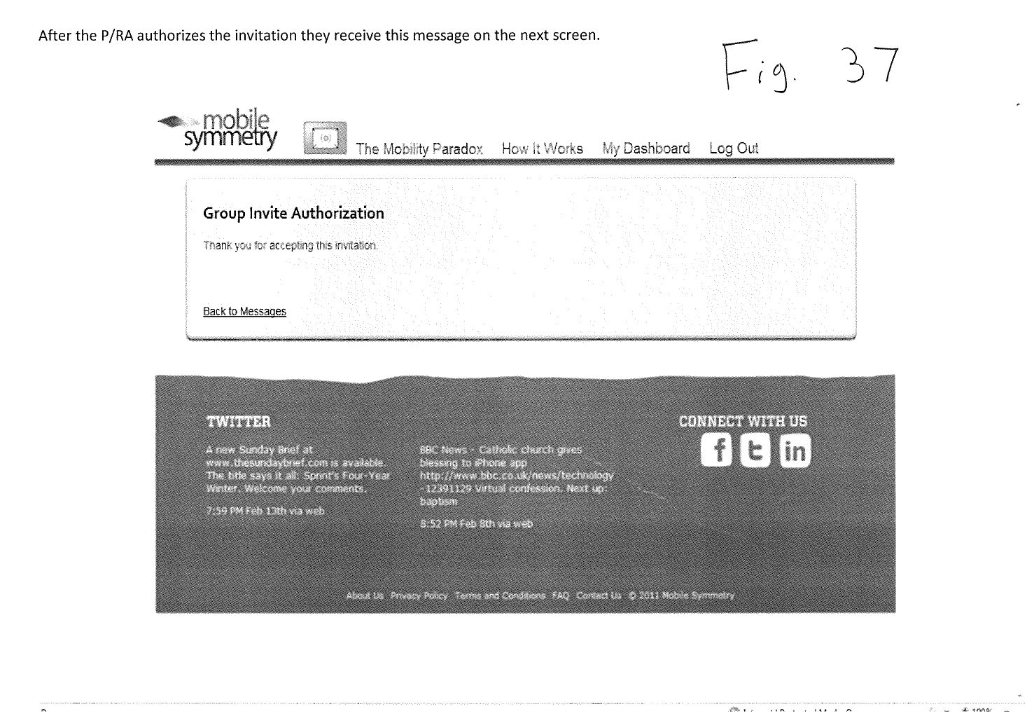

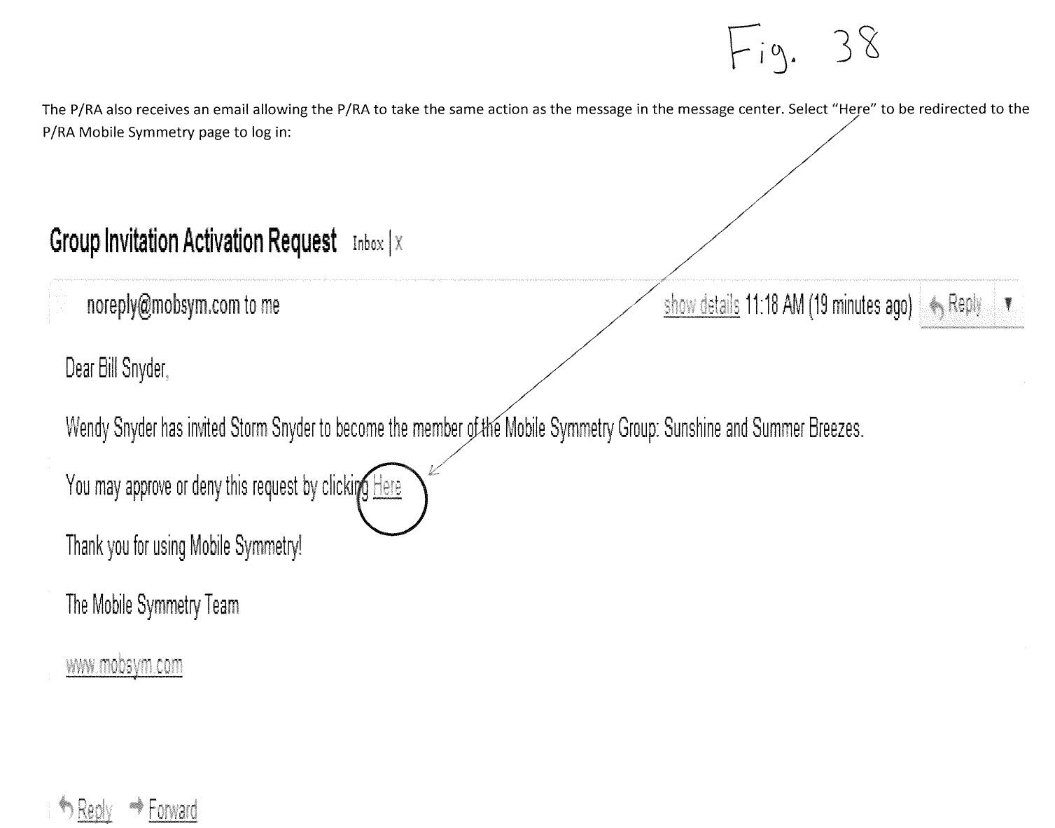

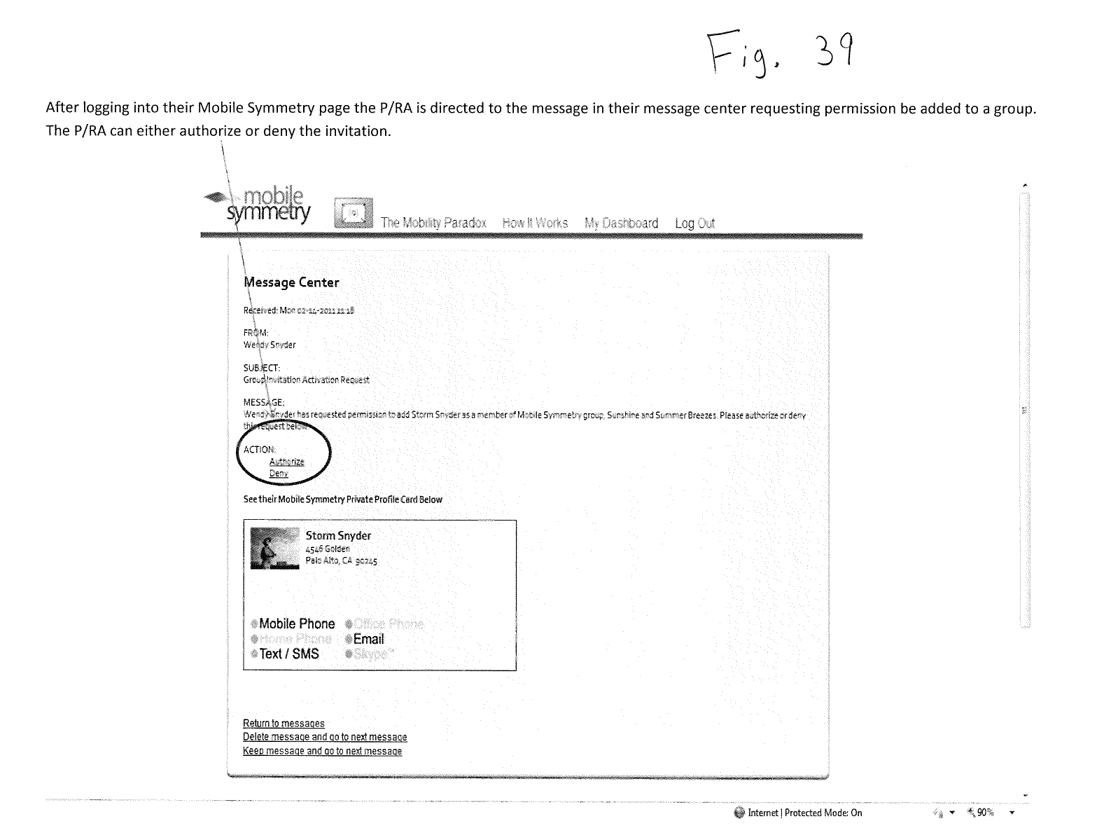

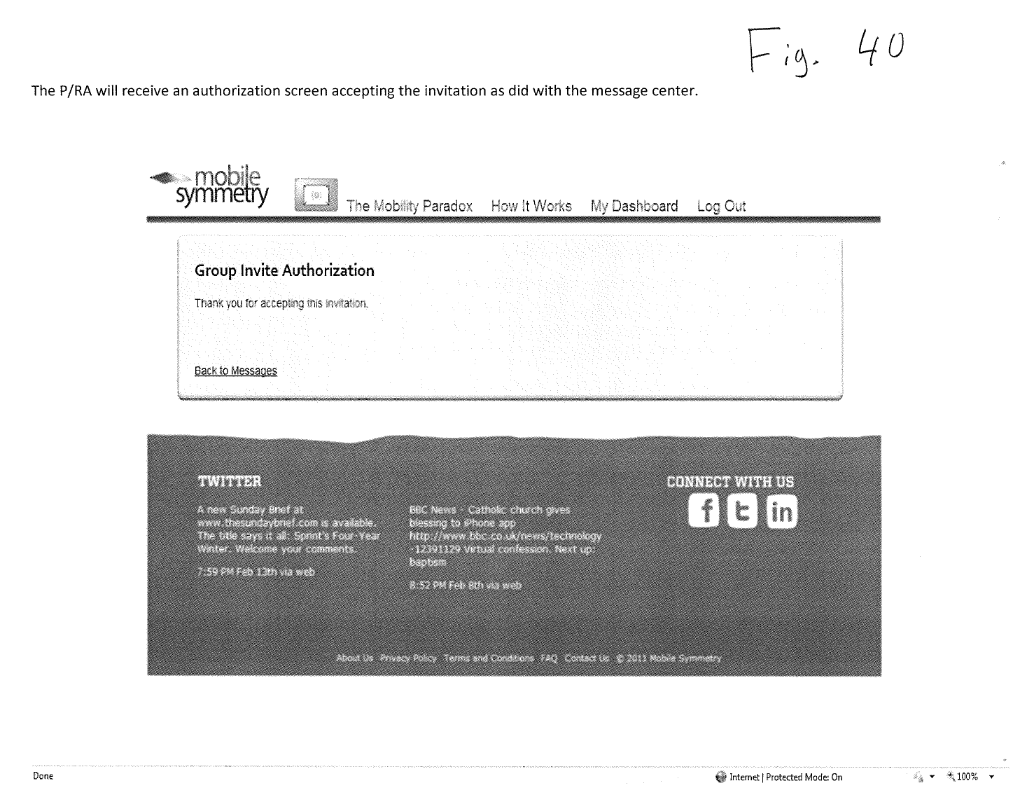

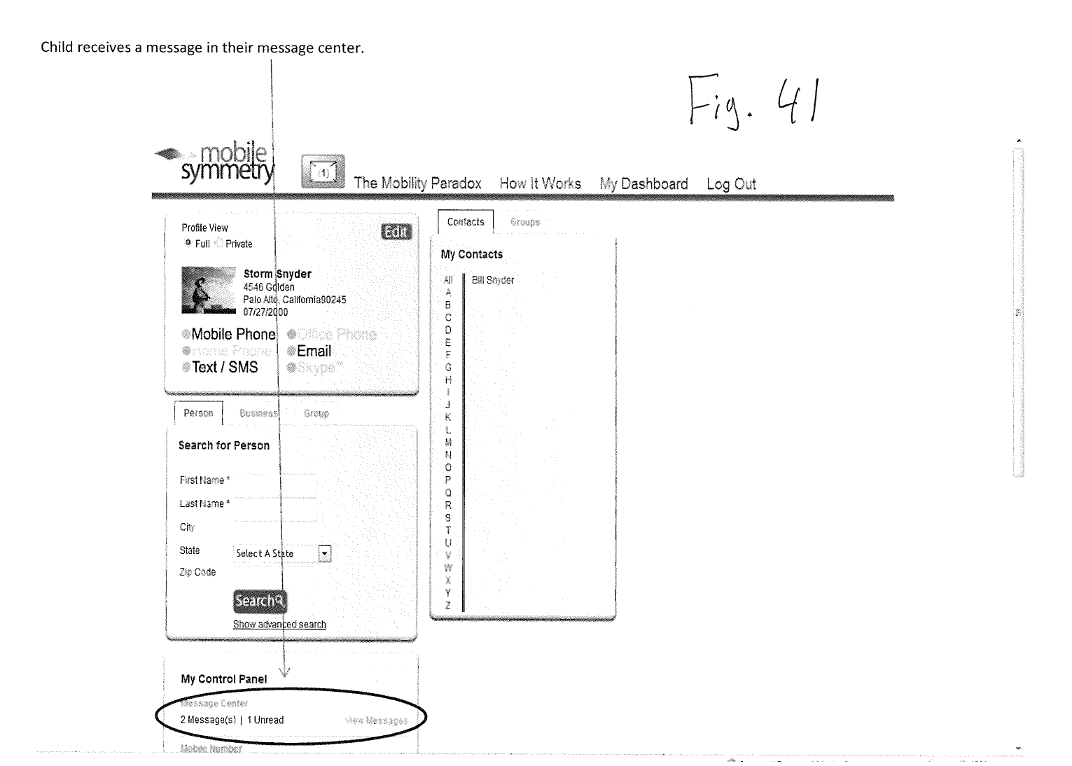

The flow charts of FIGS. 2 and 3 and the screen shots of FIGS. 4-55 show the functionality and operation of implementations of the present invention in more detail. In this regard, some of the blocks of the flow charts and portions of the screen shots may represent exemplary steps in methods of the present invention and/or a module segment or portion of code of computer programs of the present invention. The module segments or code segments of the computer programs comprise one or more executable instructions for implementing the specified logical function or functions. In some alternative implementations, the functions noted in the various blocks may occur out of the order depicted in FIGS. 2 and 3. For example, two blocks shown in succession may in fact be executed substantially concurrently, or the blocks may sometimes be executed in the reverse order depending upon the functionality involved.

Referring now to FIG. 2, a method 200 of creating a group directory of mobile communication devices is depicted. The method 200 generally begins when a person with a user profile in the registry 12 accesses and logs in to the registry 12 as depicted in step 202. An exemplary log-in screen that may be displayed on the user's mobile communication device is shown in FIG. 4. The method 200 assumes the user has already created a user profile as explained in the '095 Application.

The registry 12 or another computer system in communication with the registry then displays the user's dashboard or other main screen, an example of which is shown in FIG. 5. The dashboard may display the user's profile and a search box that allows the user to search for other user profiles in the registry. A member of a group directory may search for the user profile of any other member of the group based on any field within the user profile. The dashboard also has a Contacts tab that displays all of the user's contacts and a Group tab that displays all of the Groups of which the user is a member and/or an administrator.

From the dashboard, the user may create a new group directory as depicted in Step 204 of FIG. 2. This may be done by clicking on an Add button on the dashboard in FIG. 5, which links to a page in which details for the group directory may be entered. An exemplary Create My Group page is shown in FIG. 6. The Create My Group page has a field for naming the group directory, buttons or other selectors for designating the size of the group directory, a field for describing the group directory, and fields for address and other information for the group. The page may also include buttons (labeled “Intra Group Communication” in FIG. 6) for selecting whether the group directory should be opened or closed.

The user who creates the group directory is identified as the “administrator” herein and is given certain duties and rights summarized in the table below. The Create My Group page may also include a field for designating one or more pseudo administrators who may also be given rights and duties summarized in the table. The first line of the table applies to open group directories and the second line applies to closed group directories.

Group directories may be designated as private or public. For private directories, if an individual with a user profile who is not a group directory member searches for the group, the returned results will be “not found.” If the directory is public, any individual with a user profile may search for the group and request to join the group. The request to join is submitted to the directory administrator.

| | Pseudo Admin | |
|---|---|---|
| Administrator | (with rights delegation) | Members |
| Full communication access to all group | Full communication access to | Access to all other group |
| members individually or via broadcast | all group members individually | members & administrators. |
| messaging | or via broadcast messaging | May contact members and |
| Maintenance of group list | Maintenance of group list | administrators using any |
| Delegate Pseudo Admin rights | | means published in their |
| | | profile |
| | | Can receive and reply to |
| | | messages |
| Full communication access to all group | Full communication access to | Cannot view or contact group |
| members individually or via broadcast | all group members individually | members |
| messaging | or via broadcast messaging | Can contact administrators or |
| Maintenance of group list members | Maintenance of group list | respond to a message |
| Delegate Pseudo Admin rights | | Can receive and reply to |
| | | messages |

Once all of the required fields of the Create My Group page or similar page are populated, the administrator may click on a Next button and be presented with the screens shown in FIGS. 7 and 8 for providing payment information. Once payment is made, the administrator may be required to accept certain Terms and Conditions and then click on a Submit button. The registry 12 may then send the administrator a Thank You message or link, an example of which is shown in FIG. 9.

The next step in the method 200 is for the administrator to invite others to join the group directory as depicted in Step 206. This may be done by clicking on a link in the page of FIG. 9, which then leads to a page shown in FIG. 10 that allows the administrator to add individual members or to batch import multiple members. To add an individual member, the administrator may provide the member's name, mobile phone number, and email address in the fields shown in FIG. 10 and click on an Add button. Each time the administrator adds a new member, he or she may be presented with a “Member Invited Successfully” message shown in FIG. 11.

To batch import multiple members, the administrator may select a Batch Import button and then click on a Browse button to search for spreadsheets of member information as shown in the exemplary pages of FIGS. 12 and 13. The administrator may then select a file to import and click on an Import button as shown in FIG. 14. When the file has been successfully imported, the administrator may then be presented with an “Import Members Complete” message as shown in FIG. 15.

The next step in the method 200 is for the registry 12 or another computer system to create and send invitations to the invited members as depicted in Step 208. Before sending the invitations, the registry may cross reference the contact information for the invited members provided by the administrator to determine which of the invited members already have user profiles in the registry as depicted in Step 210. If an invited member does not have an existing user profile, the registry may send the invited member an invitation to join the group directory as depicted in step 211 and an invitation to create a user profile as depicted in Step 212. The invited member may crate a user profile as described in the '095 Application. If the invited member already has a user profile, the method 200 continues to Step 214 where the registry sends the invited member an invitation via email as shown in FIG. 16. If the invited member wishes to accept the invitation, he or she clicks where indicated and is directed to his or her user profile Message Center as shown in FIG. 17.

The method continues when the invited member is prompted to accept the invitation and choose a profile for the group directory as depicted in Step 216 of FIG. 2 and the exemplary Message Center page of FIG. 17. After the member has accepted the invitation and selected a profile to be added to the group directory, the registry sends the member an acknowledgment as depicted by Step 218 of FIG. 2 and the page shown in FIG. 18.

When an invitation is sent, regardless of whether the invited member has an existing user profile, the registry 12 holds the invitation by using a task ID associated with the link in the invitation. When the invited member clicks on the link in the email invitation (or from the Message Center for current profile owners), the registry 12 keeps the task ID related with the invitation to join the group until the approve/deny action has been taken. If the invited member does not have a user profile, the registry keeps the task ID related to the invite so that once the profile is created, the registry knows to then provide the action for the invite.

The above-described steps and exemplary screen pages were for inviting adults to join a group directory. The administrator may also invite minors and children to join. Importantly, the registry of user profiles and all other features of the present invention follow guidelines of the Children's Online Privacy Protection Act (COPPA) and similar pending proposals for children and minors (children are under 13 years of age, minors are between 13 or older and under 18). All child and minor profile information is protected starting with the initial requests for information from the child/minor, through the gathering of the information, and to the storing and access of the information. For example, a child is only allowed to have a private view in a group directory, whereas a minor may have a public view and a private view. For a child profile, one or more responsible adults must be designated, and the responsible adult(s) must approve the child's profile before it is posted and added to a group directory. The responsible adult must also approve all views of the profile, which directories the child opts into, and any changes to the profile. Similar protections are provided for minor profiles, except with a minor profile, the responsible adult(s) must approve the initial profile and then may elect to either approve all profile changes and directory access or just be notified of the same.

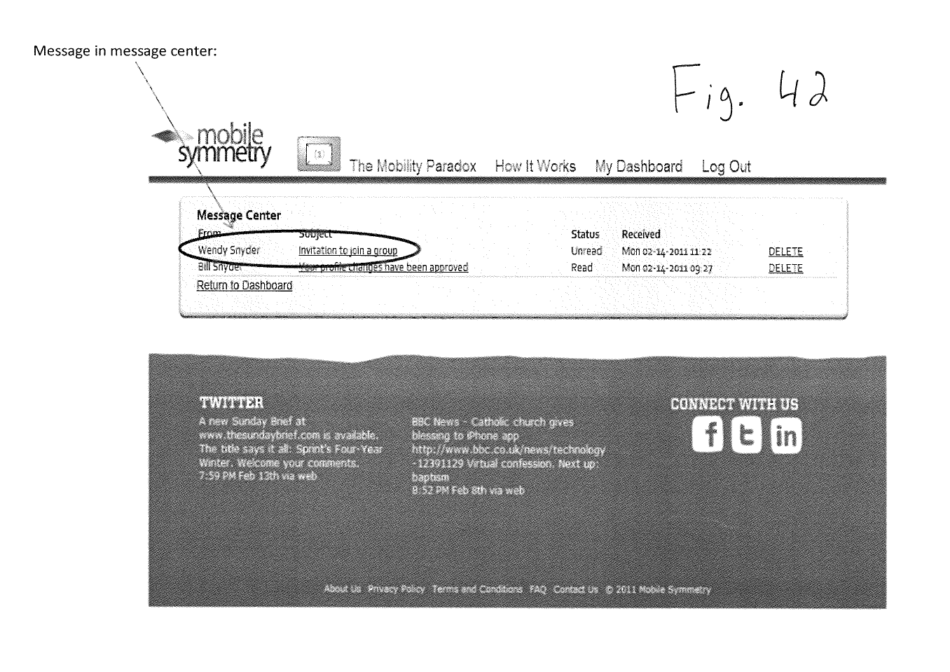

To invite a minor to join a group directory, the administrator may populate the fields shown in FIGS. 19 and 20 in the same manner as described above with respect to inviting adults. However, after the administrator invites a minor to join, the registry sends an invitation to a parent or other designated responsible adult, not to the minor. The invitation is sent to the responsible adult's Message Center as shown in FIGS. 21 and 22 and is also sent via email with a link to the Message Center. The parent or other responsible adult may then accept or decline the invitation on behalf of the minor as shown FIGS. 23 and 24. Only after the parent or other responsible adult accepts the invitation does the minor receive an invitation to join the group directory as depicted in FIGS. 25 and 26. As with adults, the minor may then accept the invitation and select which profile to add to the group directory as shown in FIGS. 27 and 28. The minor may then be sent an acknowledgment as shown in FIG. 29. This example is for when a minor's responsible adult has chosen to approve all profile activity. If the responsible adult chooses to be notified of profile activity only (no approval), the approval process shown and described is not performed.

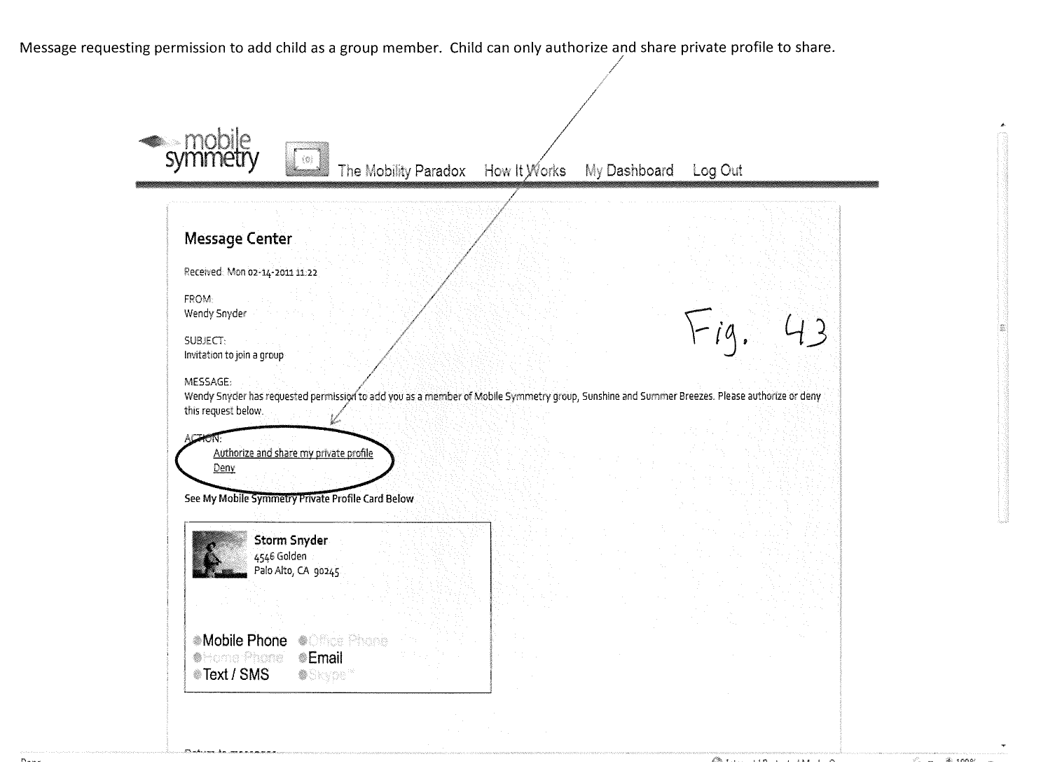

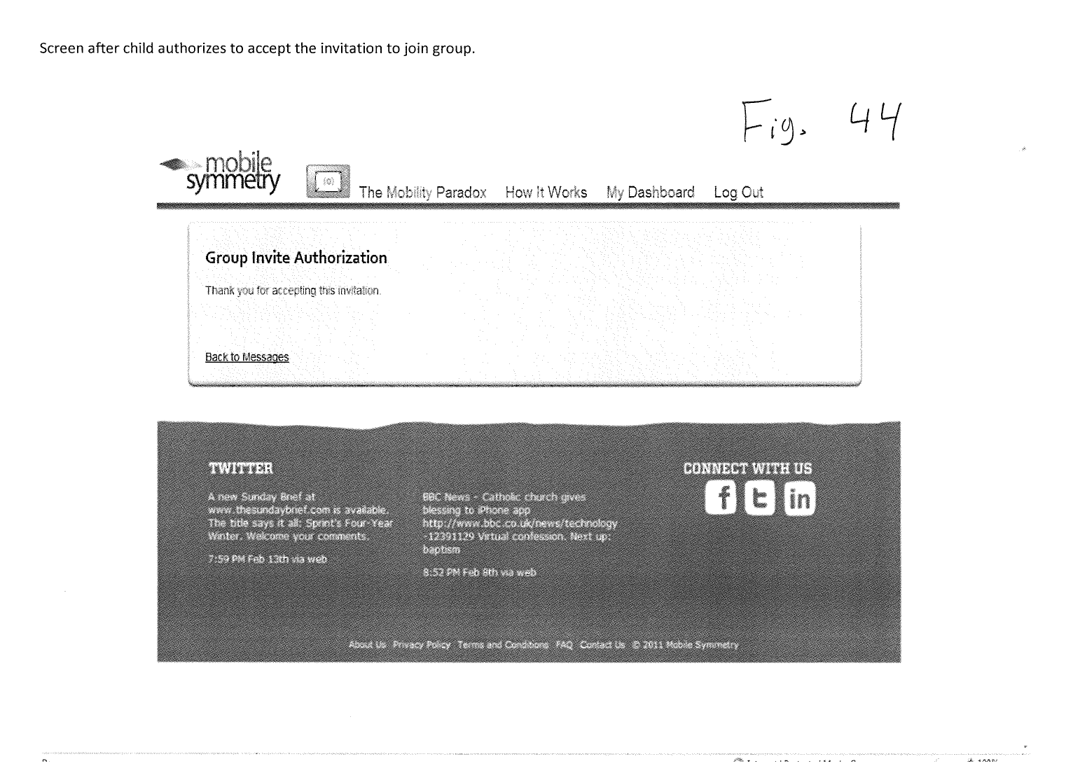

Once the minor has been added to a group directory, the group directory name is added to the minor's list of groups as shown in FIG. 30. Any other member of the group may then access his or her own dashboard through their user profile, select the group from the group list, and then view the minor's designated profile and all other members' profiles as shown in FIG. 31.

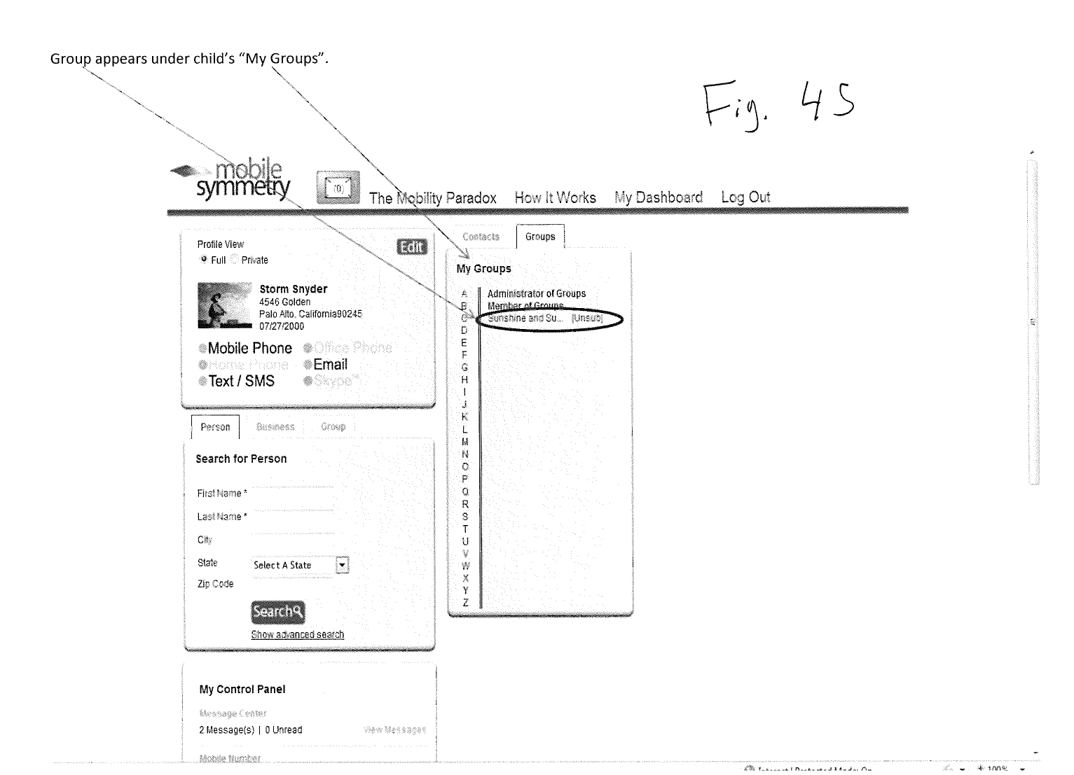

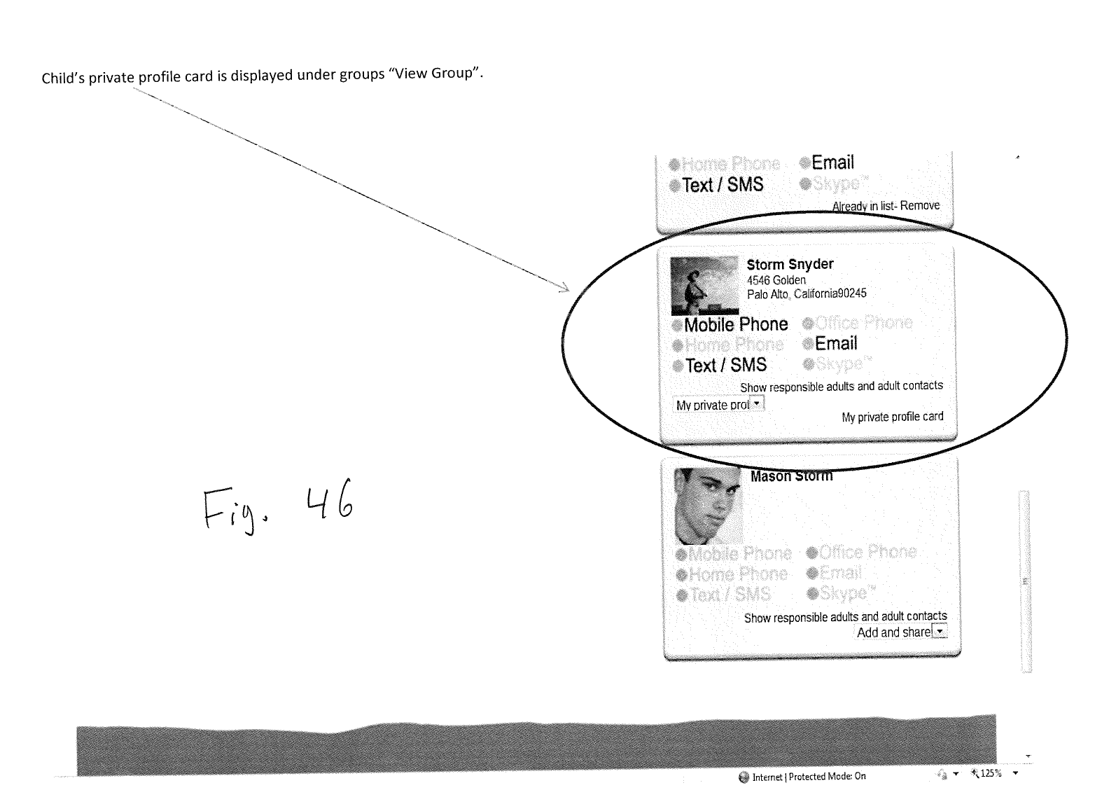

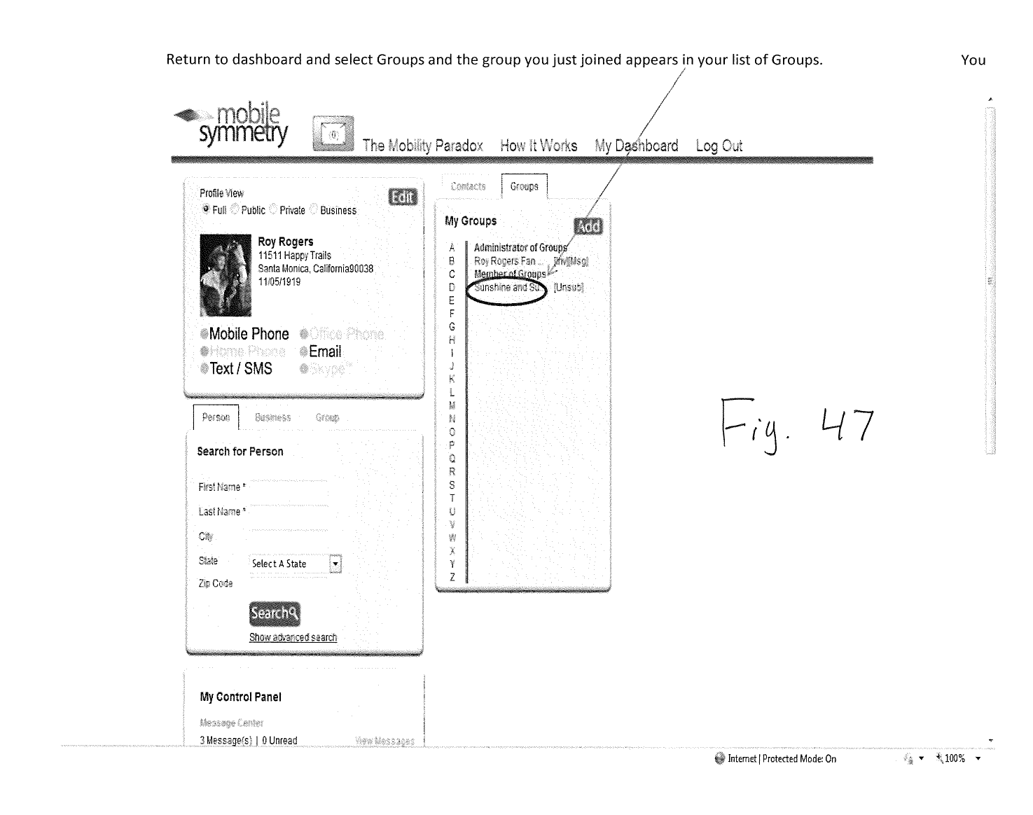

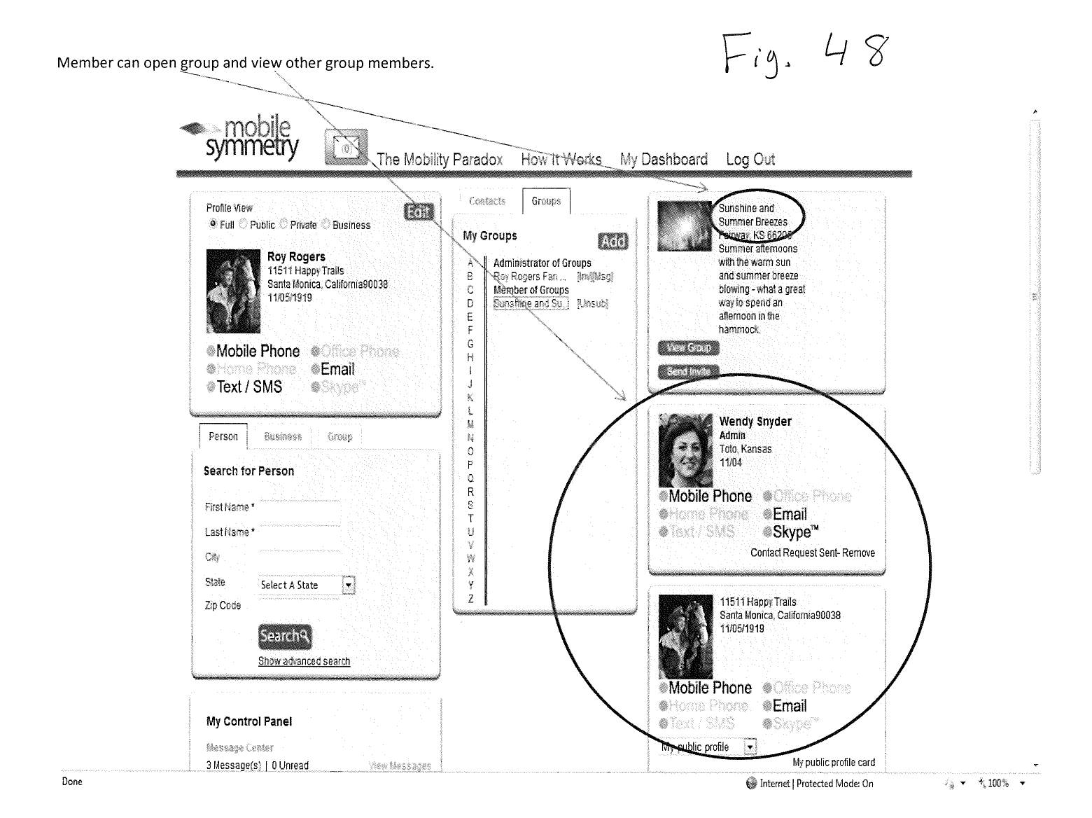

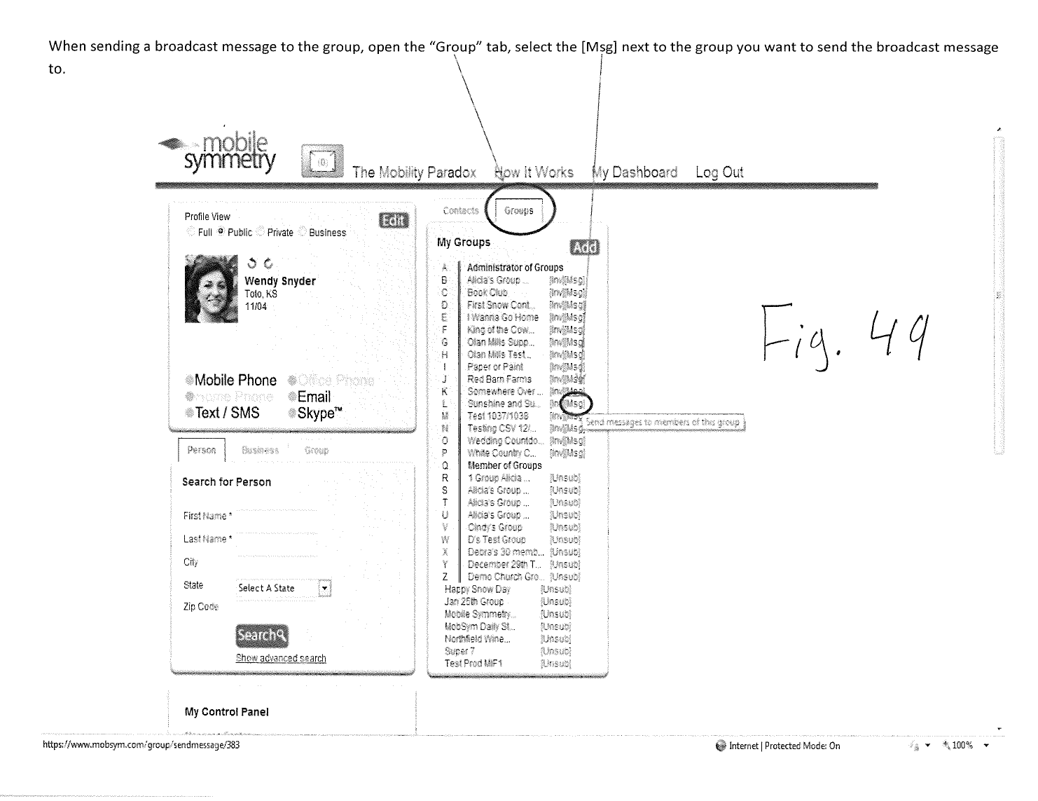

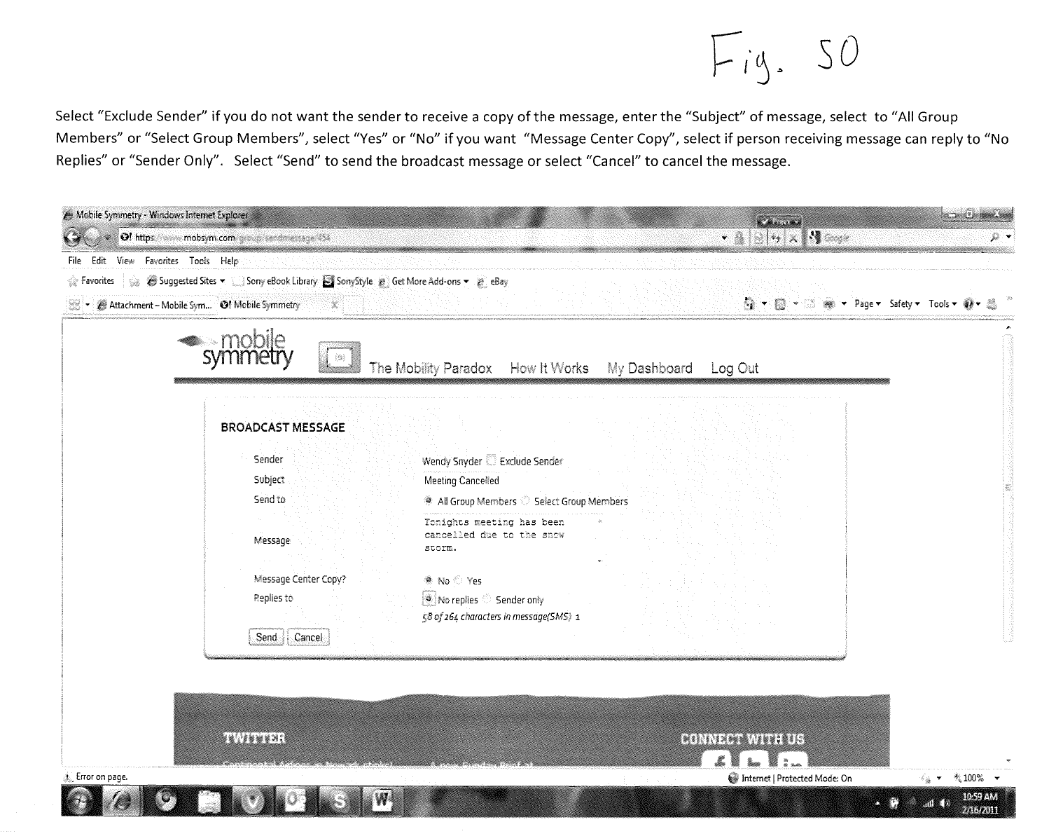

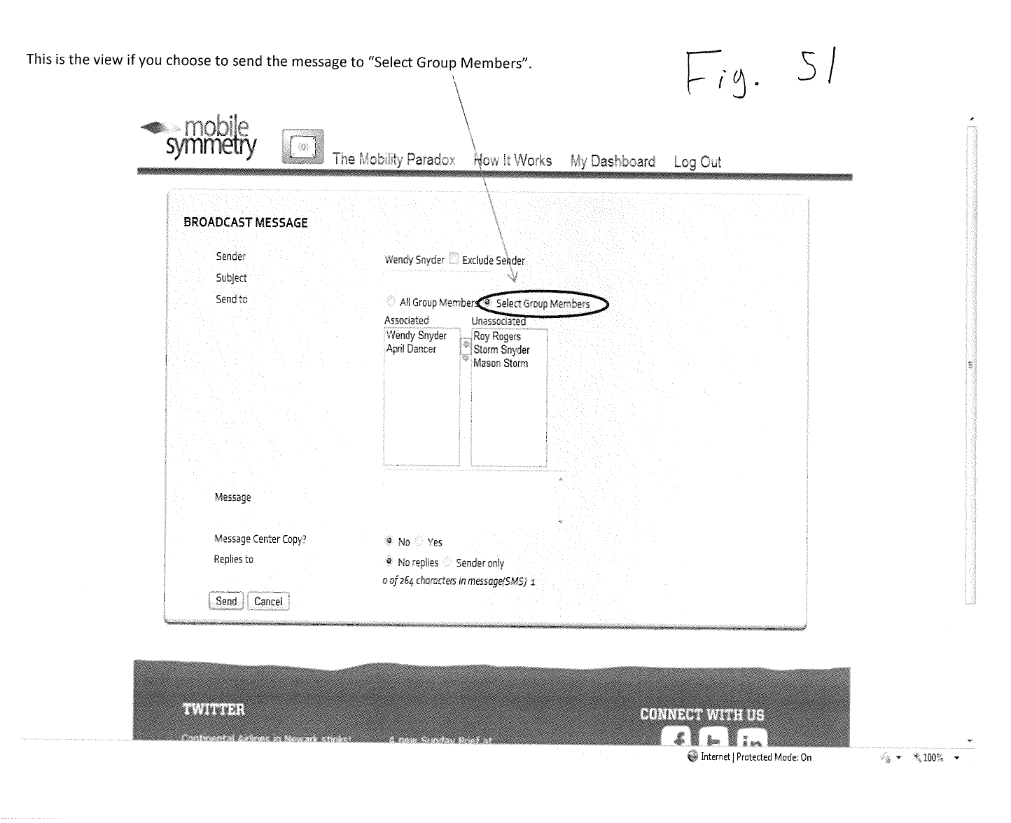

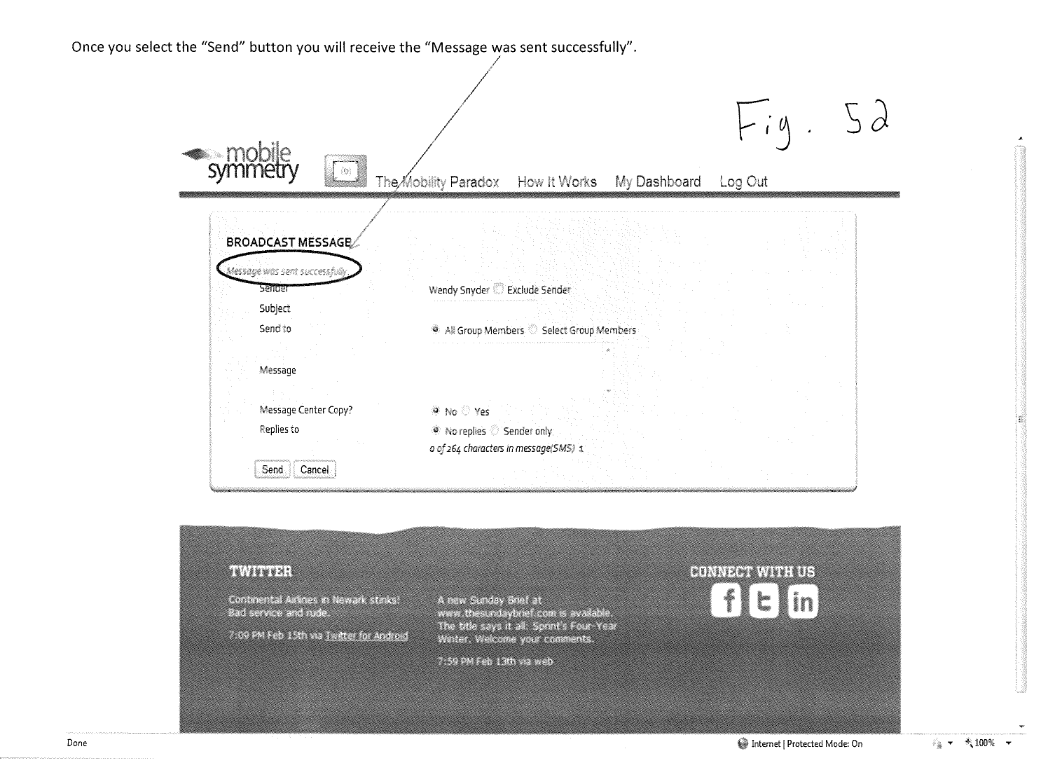

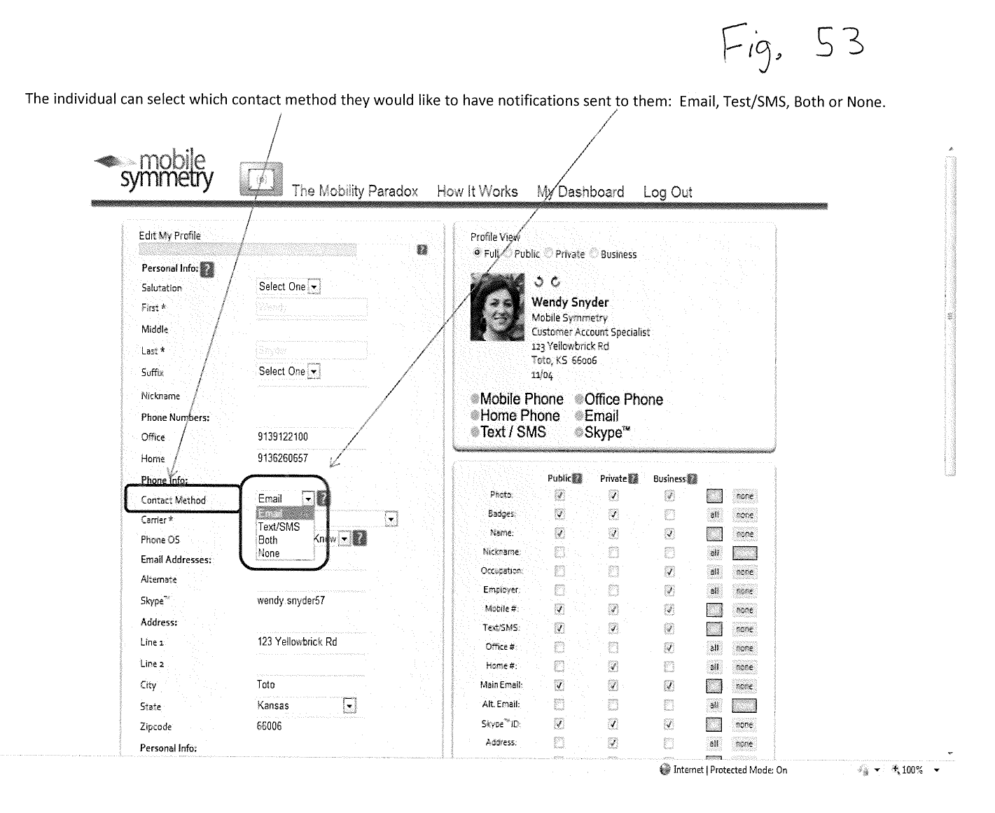

The process to invite a child is similar to the process to invite a minor, except that more limitations are placed on the posting and access of the child's profile. Specifically, the administrator may populate the fields shown in FIGS. 32 and 33 in the same manner as described above with respect to adults and minors. After the administrator invites a child to become a new member, the registry sends the invitation to a parent or other designated responsible adult. The invitation is sent to the responsible adult's Message Center as shown in FIGS. 34 and 35. The parent or other responsible adult may then accept or decline the invitation on behalf of the child as shown FIGS. 36 and 37. The parent or other responsible adult also receives an email request as shown in FIG. 38 with a link to the Message Center. Only after the parent or other responsible adult has accepted the invitation does the child receive an invitation to join the group directory as depicted in FIGS. 41 and 42. Unlike with adults and minors, the child is not permitted to add anything other than his or her private profile to the group directory as shown in FIG. 43. The child may then be sent an acknowledgment as shown in FIG. 44.

Once the child has been added to a group directory, the group directory name is added to the child's list of groups as shown in FIG. 45. Any other member of the group may then view the child's private profile and all other members' designated profiles as shown in FIG. 46.

Any member of a group directory may access his or her dashboard at any time and view a list of all their groups as shown in FIG. 47. The member opens a group directory by clicking on the group name and may view the designated profiles of other group members as shown in FIG. 48. Each group directory is assigned a specific key based on the group directory name. The registry uses this specific key as a secondary key to find each member that is part of a group directory. Individual members have a secondary key for each group directory they are a member of so that their user profiles can be linked to each group directory.

The method 200 may also be used to create subgroup directories within a master group directory in order to serve specialized interests within the main group. An example of this need is a church that has its entire membership in a master group directory. Within the community of the church are many activity and leadership groups that have unique topics of communication that apply to only the members of those groups and not the larger community as a whole (e.g. youth group/choir). The subdirectories create associated groups within a larger group directory, governed by the overall group administrator. A subgroup directory may be private or public, but if the master directory is private, all subgroup directories must be private as well. A subgroup directory may have a child or minor as the administrator, but in such case the subgroup directory must be private and all its members must be in the master directory. All child/minor approval processes remain intact when a child or minor is a subgroup administrator.

The present invention also provides a method 300 of creating and sending messages using a group directory as depicted in FIG. 3. An administrator or pseudo-administrator of a group directory may use the method 300 to send broadcast messages or other communications to all members of a group and the members themselves may reply to the messages. The administrator first logs into the registry 12 and access his or her dashboard as depicted in Step 302 and shown in FIG. 49. The administrator may then open a group and select a Msg tab or button next to the group name and be directed to a message creating screen such as the Broadcast Message screen shown in FIG. 50. The screen has buttons for indicating whether a message should be sent to all group members or only designated group members. The screen also has an Exclude Sender button that may be checked if the administrator does not want his or her name sent with the message, a subject field for indicating the purpose of the message, a message field for providing the actual message, selector buttons for indicting whether a copy of the message should be sent to the sender's Message Center, and selector buttons for indicting whether members may reply to the message.

FIG. 51 shows an exemplary screen for designating which members will receive a message. FIG. 52 shown an exemplary acknowledgment screen that may be displayed after a message has been successfully sent.

Importantly, each member of a group directory may designate how they wish to be contacted when they initially create or later edit their user profile. For example, as shown in the exemplary screen of FIG. 53, a group member may designate that he or she only wants to be contacted for broadcast messages by email, text, voice, or some other method. Each member may also request to receive no communications. A member may also elect to show a Google map or other map of their address on their user profile as shown in FIGS. 54 and 55.

An embodiment of the invention may also include a client software application that may be loaded on the mobile communication device of each user who wishes to access the registry 12 of user profiles. The client software application includes a look-up function that permits a user to enter a name and/or other identifying information for a person the user wishes to call and to transmit a corresponding look-up request to the registry. Importantly, the look-up request is transmitted from the requesting mobile communication device to the registry over a data channel independent of a subsequent voice channel established between the requesting mobile communication device and the called mobile communication device. Alternatively, mobile communication devices or other electronic devices without the client software application may launch a browser and access the registry via a WAP site to search for user profiles.

Once the registry receives a look-up request, it searches the user profiles, locates a user profile that matches the look-up request, and provides the user profile to the requesting mobile communication device. The client software application on the requesting mobile communication device then displays the user profile owner's name and other information but does not display the user profile owner's phone number. The requesting party may then click on links in the user profile to contact the user profile owner via any of the user profile owner's allowed communication methods (e.g. mobile communication device call, text, email). The user profile may also require the requestor to seek permission before contacting the user profile owner directly.

As the requesting mobile communication device (also referred to as the “calling mobile communication device”) calls the mobile communication device associated with the user profile (also referred to as the “called mobile communication device”), the called mobile communication device queries the registry for the user profile of the calling mobile communication device and displays the user profile. This enables the called party to view the user profile of the calling party as the phone call is being established between the parties. As with the look-up request transmitted to the registry from the calling mobile communication device, the query from the called mobile communication device to the registry is sent over a data channel.

Although the invention has been described with reference to the preferred embodiment illustrated in the attached drawing figures, it is noted that equivalents may be employed and substitutions made herein without departing from the scope of the invention as recited in the claims. For example, although a client software application as described above is preferably loaded on every mobile communication device that uses the registry, this is not required as mobile communication devices and other computing devices without the software application may still access the registry with a web browser to search for a user profile. Similarly, the software application is not required to create and post a user profile on the registry. However, the software application is currently necessary to obtain and display a user profile for an incoming call.

Although embodiments of the invention described and illustrated herein primarily refer to directory services for mobile communication device calls, any wireless communications may be supported by the present invention including SMS text messages, multi-media message service (MMS) messages, SMTP messages, Skype, and email.

Having thus described the preferred embodiment of the invention, what is claimed as new and desired to be protected by Letters Patent includes the following:

1. A method of providing group directory services for mobile communication devices, the method comprising the steps of:
maintaining a registry of user profiles established and maintained by mobile communication device users, wherein each user profile includes data representative of a user's name and preferred contact method; and
permitting a group administrator to access the registry and create a group directory consisting of at least some members who have user profiles in the registry by linking the members' user profiles to the group directory.

2. The method as set forth in claim 1, further comprising the steps of:
permitting the group administrator to access the group directory and create a message; and
sending the message to designated group members in accordance with each member's preferred contact method.

3. The method as set forth in claim 1, further comprising the step of permitting the members of the group directory to access the user profiles of other members of the group directory.

4. The method as set forth in claim 1, further comprising the steps of:
receiving at the registry a look-up request from a calling mobile communication device;
accessing the registry and locating a user profile that matches the look-up request; and
providing information from the matched user profile to the calling mobile communication device for display thereon.

5. The method as set forth in claim 1, wherein each user profile includes permission information that enables each member to determine who may contact them.

6. The method as set forth in claim 4, wherein the look-up request is transmitted to the registry over a data channel and is generated with a client software application operating on the calling mobile communication device or is generated via a web or WAP access to the registry.

7. The method as set forth in claim 4, further comprising the steps of:
receiving from a called mobile communication device data representative of the phone number of the calling mobile communication device;
accessing the registry and retrieving a user profile for the calling mobile communication device; and
providing to the called mobile communication device information from the user profile for the calling mobile communication device.

8. A method of providing group directory services for mobile communication devices, the method comprising the steps of:
maintaining a registry of user profiles established and maintained by mobile communication device users, wherein each user profile includes data representative of a user's name and preferred contact method;
permitting a group administrator to access the registry and request to create a group directory consisting of members who have user profiles in the registry;
sending to the members invitations to join the group directory;
receiving acceptances from at least some of the members;
linking to the group directory the user profiles of the members who agree to join the group directory; and
allowing the group administrator to determine whether the members of the group directory can access the user profiles of other members of the group directory.

9. The method as set forth in claim 8, further comprising the steps of:
permitting the group administrator to access the group directory, create a message, and designate members for the message; and
sending the message to the designated members in accordance with each member's preferred contact method.

10. The method as set forth in claim 8, further comprising the steps of:
receiving at the registry a look-up request from a calling mobile communication device;
accessing the registry and locating a user profile that matches the look-up request; and
providing information from the matched user profile to the calling mobile communication device for display thereon.

11. The method as set forth in claim 8, wherein each user profile includes permission information that enables each member to determine who may contact them.

12. The method as set forth in claim 10, wherein the look-up request is transmitted to the registry over a data channel and is generated with a client software application operating on the calling mobile communication device or is generated via a web or WAP access to the registry.

13. The method as set forth in claim 10, wherein the look-up request includes a name and a geographic location of a person.

14. A system for providing group directory services for mobile communication device users, the system comprising:
a registry for storing user profiles created and maintained by a plurality of mobile communication device users, each user profile having information representative of user's name and preferred contact method; and
a first computer program stored on memory associated with the registry, the first computer program comprising—
a code segment for permitting a group administrator to access the registry and request to create a group directory consisting of members who have user profiles in the registry;
a code segment for sending to the members invitations to join the group directory;
a code segment for receiving acceptances from at least some of the members;
a code segment for linking to the group directory the user profiles of the members who agree to join the group directory; and
a code segment for permitting the members of the group directory to access the user profiles of other members of the group directory.

15. The system as set forth in claim 14, the first computer program further comprising a code segment for receiving a look-up request from a calling mobile communication device; a code segment for accessing the central registry and obtaining contact information for a called mobile communication device that matches the look-up request; and a code segment for providing the contact information for the called mobile communication device to the calling communication device.

16. The system as set forth in claim 15, further comprising a second computer program stored on memory of the calling mobile communication device, the second computer program comprising a code segment for generating the look-up request and transmitting it to the registry; a code segment for receiving the contact information for the called mobile communication device; and a code segment for initiating a communication between the calling mobile communication device and the called mobile communication device using the contact information.

17. The system as set forth in claim 15, the second computer program further including a code segment for transmitting information that identifies a reason for a call to the called mobile communication device during or after establishment of the voice channel between the calling mobile communication device and the called mobile communication device.

18. The system as set forth in claim 15, the first computer program further including a code segment for determining if the calling mobile communication device and the called mobile communication device are both served by the same wireless phone carrier, and if so, transmitting information to the called mobile communication device to indicate such.

19. The system as set forth in claim 15, the first computer program further including code segments for receiving from the called mobile communication device data representative of the phone number of the calling mobile communication device as a voice channel is being established between the calling mobile communication device and the called mobile communication device; accessing the registry and retrieving a user profile for the calling mobile communication device; and providing to the called mobile communication device information from the user profile for the calling mobile communication device.
